(19) United States
(12) Patent Application Publication
(10) Pub. No.: US 2017/0365013 A1
(43) Pub. Date: Dec. 21, 2017

(54) DEVICE AND METHOD OF PROVIDING SOCIAL NETWORK SERVICE WITH CLICK

(71) Applicant: SAMSUNG ELECTRONICS CO., LTD., Suwon-si (KR)

(72) Inventors: Pankaj AGARWAL, Suwon-si (KR); Kwang-choon KIM, Suwon-si (KR)

(73) Assignee: SAMSUNG ELECTRONICS CO., LTD., Suwon-si (KR)

(21) Appl. No.: 15/602,498

(22) Filed: May 23, 2017

Related U.S. Application Data
(60) Provisional application No. 62/353,026, filed on Jun. 21, 2016.

(30) Foreign Application Priority Data
Nov. 24, 2016 (KR) 10-2016-0157429
Mar. 31, 2017 (KR) 10-2017-0042257

(51) Int. Cl. G06Q 50/00; G06F 3/0482; G06F 3/0346; H04B 1/3827; H04W 8/24; H04L 29/08

(52) U.S. Cl. CPC G06Q 50/01; H04W 8/24; H04L 67/146; G06F 3/0346; H04B 1/3833; G06F 3/0482; H04L 67/10

(57) ABSTRACT

Provided are a mobile device and method of providing a social networking service (SNS) with one click. The method includes: receiving an identifier regarding the external device and an identifier regarding a user input that is input to the external device, from the external device; transmitting the identifier regarding the external device and the identifier regarding the user input to a server; receiving content about the external device and the user input from the server, based on the identifier regarding the external device and the identifier regarding the user input; and displaying the received content on a screen.

### CROSS-REFERENCE TO RELATED APPLICATIONS

This application claims the benefit of U.S. Provisional Application No. 62/353,026, filed on Jun. 21, 2016 in the United States Patent and Trademark Office, and Korean Patent Application No. 10-2016-0157429, filed on Nov. 24, 2016, and Korean Patent Application No. 10-2017-0042257, filed on Mar. 31, 2017, in the Korean Intellectual Property Office, the disclosures of which are incorporated herein in their entireties by reference.

### BACKGROUND

### 1. Field

The present disclosure relates to a mobile device and method of providing a social networking service (SNS) with one click, and more particularly, to a mobile device and method of providing content about an external device, based on an identifier regarding the external device and an identifier regarding a user input that is input to the external device.

### 2. Description of the Related Art

Due to the development in network and multimedia technologies, a user may get access to various services by using a mobile device. For example, the user may share information with other users who have certain interests by using the mobile device and may build new social relations.

However, a user using an existing mobile device has experienced inconvenience because he/she needs to search for a certain service by using the mobile phone in order to receive a service regarding an external device or a service regarding a product related to the external device. Thus, technology by which a mobile device easily provides a service regarding an external device is required.

### SUMMARY

Provided are a mobile device and method of providing content about an external device, based on an identifier regarding the external device and an identifier regarding a user input that is input to the external device.

Provided are a mobile device and method of registering an external device, based on a user input to the external device.

Additional aspects will be set forth in part in the description which follows and, in part, will be apparent from the description, or may be learned by practice of the presented embodiments.

According to an aspect of an embodiment, a mobile device includes: a memory in which at least one program is stored; at least one communicator configured to exchange data with an external device and a server; and a processor configured to provide content about the external device by executing the at least one program, wherein the at least one program comprises instructions to perform: receiving an identifier regarding the external device and an identifier regarding a user input that is input to the external device from the external device; transmitting the identifier regarding the external device and the identifier regarding the user input to the server; receiving content about the external device and the user input from the server, based on the identifier regarding the external device and the identifier regarding the user input; and displaying the received content on a screen.

According to an aspect of another embodiment, a method of providing, by a mobile device, content about an external device, includes: receiving an identifier regarding the external device and an identifier regarding a user input that is input to the external device, from the external device; transmitting the identifier regarding the external device and the identifier regarding the user input to a server; receiving content about the external device and the user input from the server, based on the identifier regarding the external device and the identifier regarding the user input; and displaying the received content on a screen.

According to an aspect of another embodiment, a non-transitory computer-readable recording medium has recorded thereon a program which, when executed by a computer, performs the above method.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram of an example of providing, by a mobile device, content about an external device, according to some embodiments;

FIG. 2 is a flowchart of a method of providing, by the mobile device, content about the external device, according to some embodiments;

FIG. 3 is a flowchart of a method of selecting content to be transmitted from a server to the mobile device, according to some embodiments;

FIG. 4A is a diagram of an example in which a user profile is managed by the server, according to some embodiments;

FIG. 4B is a flowchart of a method of managing, by the server, a user profile, according to some embodiments;

FIG. 5A is a flowchart of a method of receiving, by the mobile device, content about the external device when an identifier regarding a user input is a first identifier, according to some embodiments;

FIG. 5B is a diagram for explaining a method of receiving, by the mobile device, content about the external device, according to some embodiments;

FIGS. 6A to 6C are diagrams of examples of providing content about the external device when an identifier regarding a user input is a first identifier, according to some embodiments;

FIG. 7 is a flowchart of a method of receiving, by the mobile device, content about the external device when an identifier regarding a user input is a second identifier, according to some embodiments;

FIGS. 8A and 8B are diagrams of examples of providing content about the external device when an identifier regarding a user input is a second identifier, according to some embodiments;

FIG. 9A is a flowchart of a method of receiving, by the mobile device, content about an external device when an identifier regarding a user input is a third identifier, according to some embodiments;

FIG. 9B is a diagram for explaining a method of receiving, by the mobile device, content about the external device when an identifier regarding a user input is a third identifier, according to some embodiments;

FIGS. 10A to 10C are diagrams of examples of providing content about the external device when an identifier regarding a user input is a third identifier, according to some embodiments;

FIG. 11A is a flowchart of a method of receiving, by the mobile device, content about the external device when an identifier regarding a user input is an identifier indicating a collision between external devices, according to some embodiments;

FIG. 11B is a diagram for explaining a method of receiving, by the mobile device, content about the external device when an identifier regarding a user input is an identifier indicating a collision between external devices, according to some embodiments;

FIGS. 12A and 12B are diagrams of examples of providing content about the external device when an identifier regarding a user input is an identifier indicating a collision between external devices, according to some embodiments;

FIGS. 13A and 13B are diagrams of examples of registering the external device by the mobile device, according to some embodiments;

FIGS. 14 and 15 are block diagrams of the mobile device according to some embodiments;

FIG. 16 is a block diagram of the server according to some embodiments;

FIG. 17 is a diagram of a system for providing class-related content by using information received from external devices, according to some embodiments;

FIG. 18 is a flowchart of a method of displaying, by a hub device, class-related content, according to some embodiments;

FIGS. 19A and 19B are diagrams of examples of providing class-related content by the hub device based on an identifier regarding a user input from a third external device, according to some embodiments;

FIG. 20 is a diagram of an example of providing class-related content by the hub device when an identifier regarding a user input from a third external device is a first identifier, according to some embodiments;

FIG. 21 is a diagram of an example of providing class-related content by the hub device when the identifier regarding the user input from the third external device is a second identifier, according to some embodiments;

FIGS. 22A and 22B are diagrams of examples of providing class-related content by a mobile device of a teacher, according to some embodiments;

FIGS. 23A and 23B are diagrams of examples of providing class-related content by the hub device based on an identifier regarding a user input from a fourth external device, according to some embodiments;

FIG. 24 is a diagram of an example of providing class-related content by the hub device when an identifier regarding a user input is an identifier indicating a collision between the third external device and the fourth external device, according to some embodiments; and

FIGS. 25A and 25B are diagrams of examples of providing class-related content by a mobile device of a head teacher, according to some embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. In addition, for clarity, portions that are not related to the descriptions of the present disclosure are not illustrated in the drawings. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

It will be understood that when a component is referred to as being “connected to” another component, the component can be directly “connected to” the other component or “electrically connected to” the other component with intervening components therebetween. When a portion “includes” an element, another element may be further included, rather than excluding the existence of the other element, unless otherwise described.

Throughout the specification, an external device denotes a device corresponding to a product and may identify user inputs. Also, the external device may transmit, to a mobile device, an identifier regarding the external device and an identifier regarding a user input. The external device may include a user input unit including a sensor and/or a switch detecting a user input, a communicator communicating with the mobile device, and a controller controlling the user input unit and the communicator. However, a structure of the external device is not limited thereto. In addition, the external device may store information about a product regarding the external device. The information about a product may include at least one of a model name, a serial number, a manufacture number, and a product number of the product, but is not limited thereto. Furthermore, the external device may transmit the stored information to the mobile device.

In the specification, content may be various pieces of information or items which are obtained by manufacturing texts, symbols, voices, sounds, images, videos, etc. in a digital manner and distributing the same. For example, content about an external device may include, but is not limited to, at least one of detailed information for using the product regarding the external device, a graphical user interface (GUI) for uploading data about the product regarding the external device, a GUI for communicating with another user who uses a product identical to the product regarding the external device, and a video including a scene in which products that are respectively related to different external devices are used together.

Moreover, an identifier regarding a user input that is input to the external device may indicate at least one of a button input, a touch input, and a motion input. For example, a user input identified by the external device may include at least one of an input of pressing a button on the external device short, an input of pressing the button long, an input corresponding to a motion of shaking the external device, and an input of colliding two external devices with each other. However, the user input is not limited thereto. The external device may transmit an identifier regarding each user input to the mobile device. Also, the server may select content to be transmitted to the mobile device, based on the identifier.

An identifier regarding the external device may be an identifier that represents the external device. In addition, external devices having the same model name may have the same identifier. For example, when products regarding external devices are construction toys, toys that are assembled as vehicles of the same type may have the same identifier regarding the external devices. However, types of identifiers regarding external devices are not limited thereto.

In the drawings, the product regarding the external device is illustrated as a toy, but its type is not limited thereto.

Hereinafter, the present disclosure will be described in detail by explaining embodiments of the present disclosure with reference to the attached drawings.

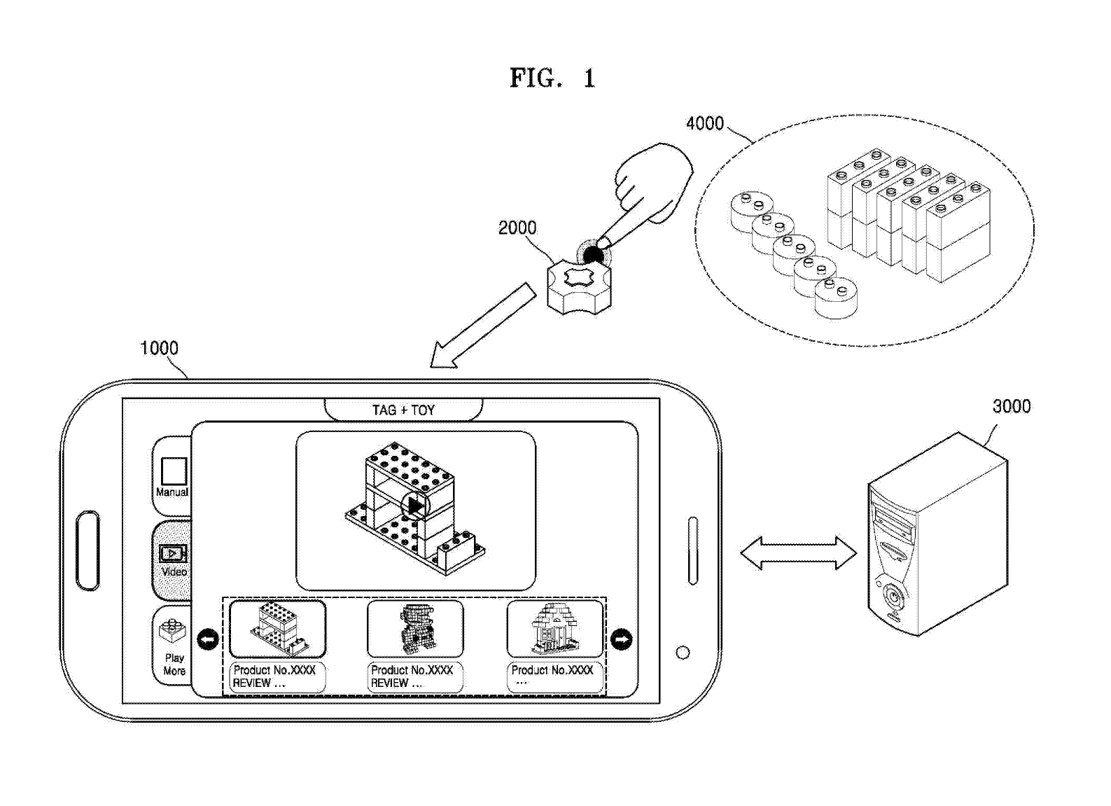

FIG. 1 is a diagram of an example of providing, by a mobile device 1000, content about an external device 2000 to a user, according to some embodiments.

Referring to FIG. 1, when a product regarding the external device 2000 is a toy 4000, the external device 2000 corresponding to the toy 4000 may transmit, to the mobile device 1000, an identifier regarding a user input and an identifier regarding the external device 2000 through short range communication, based on a user input that is input to the external device 2000. Also, the mobile device 1000 may transmit the identifier regarding the user input and the identifier regarding the external device 2000, which are received from the external device 2000, to a server 3000 and thus may send, to the server 3000, a request for providing preset content about the toy 4000 and the user input. Also, the server 3000 may provide the mobile device 1000 with content that is selected from among multiple pieces of content about the toy 4000 according to the identifier regarding the user input that is input to the external device 2000. The mobile device 1000 may display the content provided by the server 3000 on a screen of the mobile device 1000.

The toy 4000 may be a construction toy, puzzles, a radio-controlled toy, a doll, a miniature figure, or the like, but is not limited thereto. For example, when the toy 4000 is a construction toy, the toy 4000 may include multiple blocks, and the user may complete a certain shape by assembling the blocks. Shapes of the toy 4000 may include a person, a building, a vehicle, a robot, etc, but are not limited thereto.

The external device 2000 may correspond to the toy 4000 and may receive a user input regarding the external device 2000. Also, the external device 2000 may be included in the toy 4000 or may be assembled with blocks of the toy 4000. However, a structure of the external device 2000 is not limited thereto.

The mobile device 1000 may be a portable computing device. For example, the mobile device 1000 may be, but is not limited to, a smart phone, a tablet personal computer (PC), a mobile phone, a personal digital assistant (PDA), a laptop, a media player, a global positioning system (GPS), an e-book reader, a navigation device, an MP3 player, a digital camera, or another mobile computing device. Also, the mobile device 1000 may be a wearable device, for example, a watch, glasses, a hair band, a ring, or the like, which has a communication function and a data processing function. However, the mobile device 1000 is not limited thereto.

In addition, the mobile device 1000 may communicate with the external device 2000, the server 3000, and other devices (not shown) via a certain network in order to receive the identifier regarding the external device 2000 and the identifier regarding the user input and provide the content about the toy 4000. In this case, the network may include a local area network (LAN), a wide area network (WAN), a value added network (VAN), a mobile radio communication network, a satellite communication network, and a combination thereof and may indicate a data communication network that helps networked devices freely communicate with each other. The network may include wired Internet, wireless Internet, and a mobile wireless communication network. Wireless communication may be, for example, Wi-Fi, Bluetooth, Bluetooth low energy (BLE), ZigBee, Wi-Fi Direct (WFD), ultra wideband (UWB), infrared Data Association (IrDA), Near Field Communication (NFC), or the like, but is not limited thereto.

The server 3000 may provide the mobile device 1000 with jobs or content requested by the mobile device 1000. For example, the server 3000 may provide the mobile device 1000 with the content about the external device 2000 based on the identifier regarding the external device 2000 and the identifier regarding the user input that is input to the external device 2000, the identifiers being received from the mobile device 1000.

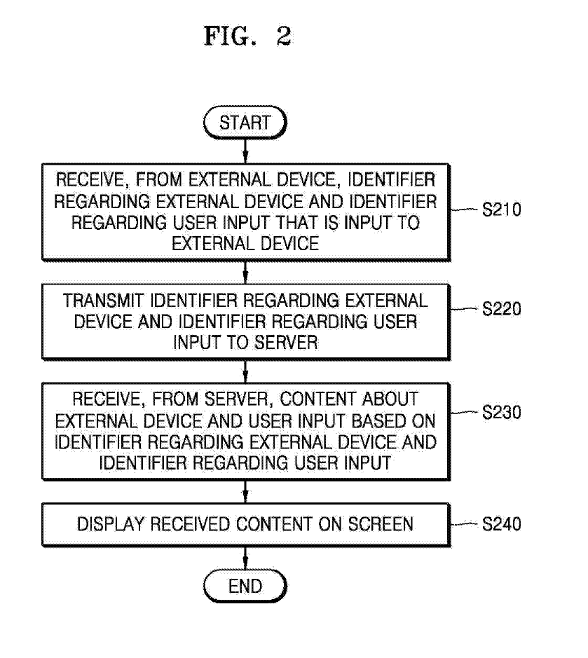

FIG. 2 is a flowchart of a method of providing, by the mobile device 1000, the content about the external device 2000, according to some embodiments.

In operation S210, the mobile device 1000 may receive, from the external device 2000, the identifier regarding the external device 2000 and the identifier regarding the user input that is input to the external device 2000. In this case, the identifier regarding the external device 2000 may be used to identify the external device 2000. The identifier regarding the user input may be an identifier corresponding to the user input in order to identify user inputs. For example, the identifier regarding the user input may indicate at least one of a button input, a touch input, and a motion input. The mobile device 1000 may communicate with the external device 2000 though short range communication in order to perform operation S210. In other words, as the mobile device 1000 comes close within a communication range of a short range communication module of the external device 2000, the mobile device 1000 and the external device 2000 may communicate with each other. For the short range communication, a communicator 1500 of the mobile device 1000 and a communicator (not shown) of the external device 2000 may each include a short range communication module.

For example, when a user presses a button on the external device 2000 in vicinity of the mobile device 1000, the external device 2000 may transmit, to the mobile device 1000, the identifier regarding the external device 2000 and an identifier indicating a button input which are stored in the external device 2000.

In operation S220, the mobile device 1000 may transmit the identifier regarding the external device 2000 and the identifier regarding the user input to the server 3000. The mobile device 1000 may display the content about the toy 4000, or an application that manages the content about the toy 4000 may be installed in the mobile device 1000 by the user. After the application is installed, the mobile device 1000 may perform operation S220 as the identifier regarding the external device 2000 and the identifier regarding the user input are received.

In operation S230, the mobile device 1000 may receive, from the server 3000, the content about the external device 2000 and the user input based on the identifier regarding the external device 2000 and the identifier regarding the user input.

For example, when a product regarding the external device 2000 is the toy 4000, the content about the external device 2000 may include at least one of detailed information for using the toy 4000, a GUI for uploading data about the toy 4000, a GUI for communicating with another user who uses a toy 4000 that is identical to the toy 4000, and a video including a scene in which two toys 4000 are used. However, the present disclosure is not limited thereto.

Also, the server 3000 may match the identifier regarding the user input with content about the product regarding the external device 2000. For example, among identifiers regarding user inputs, a first identifier may be an identifier regarding a user input of pressing the button on the external device 2000 short. In this case, the server 3000 may match the first identifier with detailed information for using the product regarding the external device 2000.

By matching the content about the external device 2000 with the identifier regarding the user input, the server 3000 may select content based on the identifier regarding the user input which is received from the mobile device 2000.

In detail, when the identifier regarding the user input is the first identifier, the mobile device 1000 may receive the detailed information for using the product regarding the external device 2000 from the server 3000. When the product regarding the external device 2000 is the toy 4000, the detailed information may include at least one of a manual of the toy 4000, a tutorial video, and information about another toy that is related to the toy 4000.

Also, when the identifier regarding the user input is a second identifier, the mobile device 1000 may receive the GUI for uploading the data about the product regarding the external device 2000 from the server 3000. When the product regarding the external device 2000 is the toy 4000, the data about the product regarding the external device 2000 may include at least one of an assembly instruction video regarding the toy 4000, user reviews, and grades.

Also, when the identifier regarding the user input is a third identifier, the mobile device 1000 may receive the GUI for communicating with another user who uses a product that is identical to the product regarding the external device 2000.

In addition, when the identifier regarding the user input indicates a user input of colliding the external device 2000 with another external device 2000, the mobile device 1000 may receive, from the server 3000, a video including a scene in which the products regarding the external devices 2000 are used together.

In operation S240, the mobile device 1000 may display the received content on the screen. For example, the received content may be received from the server 3000 in order to provide the SNS.

Also, as the identifier regarding the external device 2000 and the identifier regarding the user input are received, the mobile device 1000 may display a GUI for determining whether to display the content about the external device 2000. In addition, based on a user input through the displayed GUI, the mobile device 1000 may determine whether to display the content. For example, when two mobile devices 1000 simultaneously receive the identifier regarding the external device 2000 within a communication coverage range of the external device 2000, the mobile devices 1000 may each determine whether to display the content about the external device 2000.

The content received from the mobile device 1000 may be content determined by the server 3000 based on the information about the product regarding the external device 2000. In particular, the external device 2000 may store the information about the product and may transmit the stored information to the mobile device 1000. The mobile device 1000 may transmit the information received from the external device 2000 to the server 3000. The server 3000 may determine content to be transmitted to the mobile device 1000 by using the information about the product which is received from the mobile device 1000. In this case, the information about the product may include at least one of a model name, a serial number, a manufacture number, and a product number of the product.

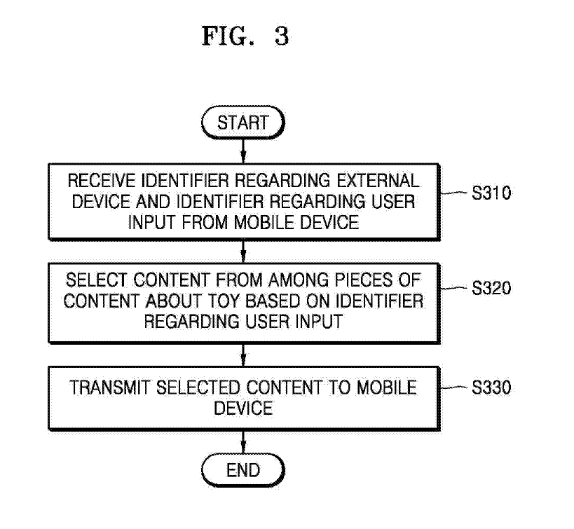

FIG. 3 is a flowchart of a method of selecting content to be transmitted from the server 3000 to the mobile device 1000, according to some embodiments.

In operation S310, the server 3000 may receive, from the mobile device 1000, the identifier regarding the external device 2000 and the identifier regarding the user input. In this case, the server 3000 may simultaneously receive the identifier regarding the external device 2000 and the identifier regarding the user input or may receive the same at a certain interval.

When the product regarding the external device 2000 is the toy 4000, the server 3000 may select the content to be transmitted to the mobile device 1000 from among pieces of the content about the toy 4000, based on the identifier regarding the user input in operation S320. In this case, the server 3000 may match the content about the toy 4000 with the identifier regarding the user input and may select the content to be transmitted to the mobile device 1000, based on a matching result.

For example, the server 3000 may retrieve pieces of content about the toy 4000 based on the identifier regarding the external device 2000. From among the retrieved pieces of content, the server 3000 may select content corresponding to the identifier regarding the user input. For example, when the product regarding the external device 2000 is a toy 4000 to be assembled as a vehicle, and when the identifier regarding the user input is an identifier corresponding to the input of pressing the button on the external device 2000 short, the server 3000 may select at least one of the manual of the toy 4000, the tutorial video, and information about another toy vehicle.

In operation S330, the server 3000 may transmit the selected content to the mobile device 1000.

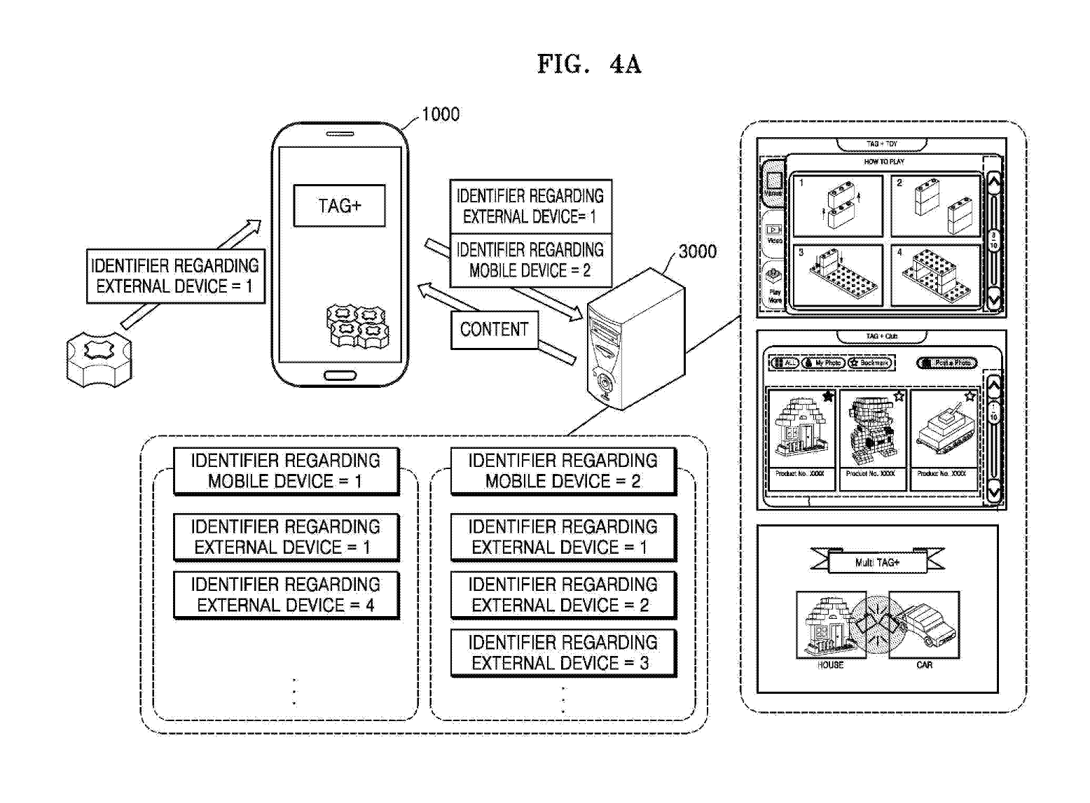

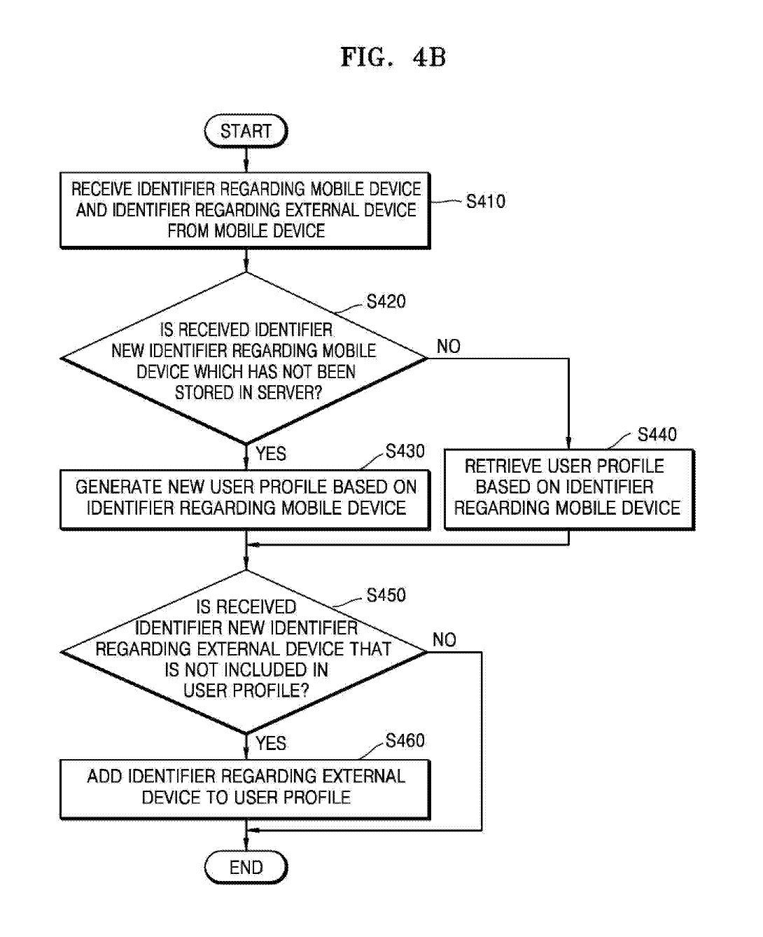

FIG. 4A is a diagram of an example in which a user profile is managed by the server 3000, according to some embodiments.

The external device 2000 may transmit the identifier regarding the external device 2000 to the mobile device 1000. In this case, the mobile device 1000 may transmit, to the server 3000, an identifier regarding the mobile device 1000 together with the identifier regarding the external device 2000 that is received from the external device 2000. The server 3000 may manage the user profile by using the identifier regarding the external device 2000 and the identifier regarding the mobile device 1000.

For example, the server 3000 may collect the identifier regarding the external device 2000 based on the identifier regarding the mobile device 1000 instead of a user identifier. Therefore, the user may receive, from the server 3000, content about the external device 2000 that the user has, by using the mobile device 1000 without a separate authentication process.

Referring to FIG. 4A, identifiers regarding external devices may be received from the mobile device 1000 having an identifier equals to 2. That is, the server 3000 may manage the user profile regarding the external device 2000 by using the identifier regarding the mobile device 1000 without the user identifier. Therefore, the server 3000 may provide the mobile device 1000 with the SNS or the information about the external device 2000 by using a combination of the identifier regarding the mobile device 1000 and the identifier regarding the external device 2000. The SNS may indicate an online service that helps users, who share interests in certain areas or activities, build social networks.

When the server 3000 adds the external device 2000 to the user profile, the mobile device 1000 may provide the user with a GUI for checking whether to add the external device 2000. Also, when the identifier regarding the mobile device 1000 is changed, the mobile device 1000 may provide the user with a GUI for checking whether to change the mobile device 1000.

FIG. 4B is a flowchart of a method of managing, by the server 3000, a user profile, according to some embodiments.

The server 3000 may generate and manage the user profile by using the identifier regarding the mobile device 1000 and the identifier regarding the external device 2000 which are received from the mobile device 1000. In other words, the server 3000 may manage the user profile by using the identifier regarding the mobile device 1000 instead of the user identifier. The server 3000 may collect information about a product that a certain user has, by using the user profile.

Referring to FIG. 4B, in operation S410, the server 3000 may receive the identifier regarding the mobile device 1000 and the identifier regarding the external device 2000. The server 3000 may simultaneously receive the identifier regarding the external device 2000 and the identifier regarding the user input from the mobile device 1000 or may receive the same at a certain time interval.

In operation S420, the server 3000 may determine whether the received identifier regarding the mobile device 1000 is a new identifier regarding the mobile device 1000 which has not been stored in the server 3000.

When the received identifier regarding the mobile device 1000 is the new identifier regarding the mobile device 1000 according to a determination result obtained in operation S420, the server 3000 may generate a new user profile based on the identifier regarding the mobile device 1000 in operation S430.

When the received identifier regarding the mobile device 1000 is an identifier regarding the mobile device 1000, which is already stored in the server 3000, according to the determination result obtained in operation S420, the server 3000 may retrieve the user profile based on the mobile device 1000 in operation S440.

In operation S450, the server 3000 may determine whether the received identifier regarding the external device 2000 is a new identifier regarding the external device 2000 which is not included in the user profile.

When the received identifier regarding the external device 2000 is a new identifier regarding the external device 2000 according to a determination result obtained in operation S450, the server 3000 may add the identifier regarding the external device 2000 to the user profile in operation S460.

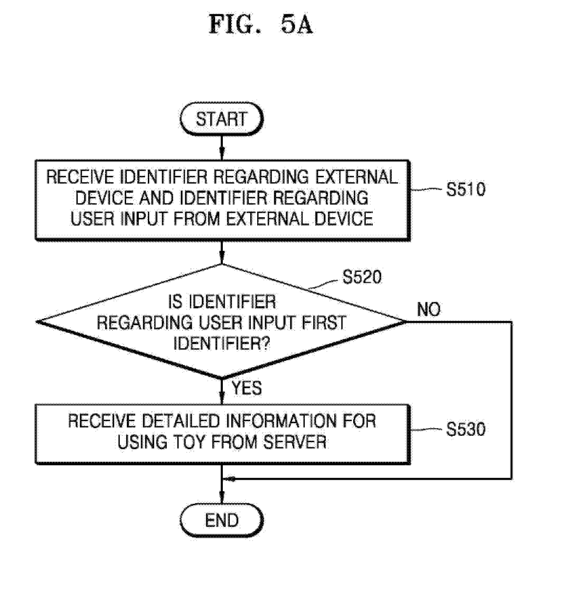

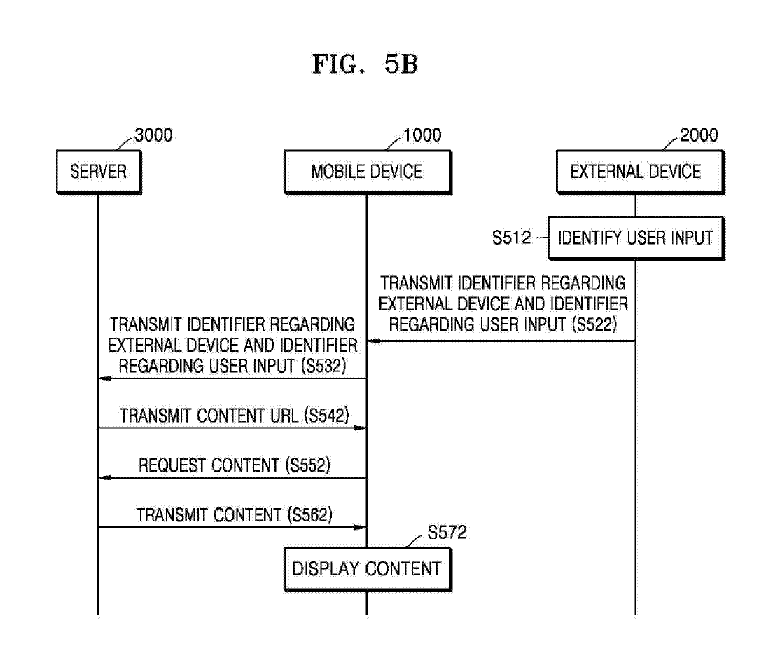

FIG. 5A is a flowchart of a method of receiving, by the mobile device 1000, the content about the external device 2000 when the identifier regarding the user input is the first identifier, according to some embodiments.

In operation S510, the mobile device 1000 may receive, from the external device 2000, the identifier regarding the external device 2000 and the identifier regarding the user input that is input to the external device 2000. Since operation S510 corresponds to operation S210 of FIG. 2, detailed descriptions thereof are omitted.

In operation S520, the mobile device 1000 may determine whether the received identifier regarding the user input is the first identifier. For example, the first identifier may be an identifier corresponding to the user input of pressing the button on the external device 2000 short. However, the present disclosure is not limited thereto.

When the received identifier regarding the user input is the first identifier according to a determination result obtained in operation S520, the mobile device 1000 may receive detailed information for using the toy 4000 from the server 3000, in operation S530. For example, the detailed information for using the toy 4000 may include at least one of the manual of the toy 4000, the tutorial video, and information about another toy regarding the toy 4000. However, the present disclosure is not limited thereto.

FIG. 5B is a diagram for explaining a method of receiving, by the mobile device 1000, the content about the external device 2000, according to some embodiments.

In operation S512, the external device 2000 may identify a user input. For example, the external device 2000 may identify a user input of pressing the button on the external device 2000 long or short.

In operation S522, the external device 2000 may transmit the identifier regarding the external device 2000 and the identifier regarding the user input to the mobile device 1000. The identifier regarding the user input may be an identifier corresponding to the user input that is identified in operation S512.

In operation S532, the mobile device 1000 may transmit the identifier regarding the external device 2000 and the identifier regarding the user input to the server 3000. Also, the mobile device 1000 may transmit an additional identifier regarding the mobile device 1000 to the server 3000 such that the server 3000 may manage the user profile.

In operation S542, the server 3000 may transmit, to the mobile device 1000, a uniform resource locator (URL) of content about the identifier regarding the external device 2000 and the identifier regarding the user input. The URL may indicate an address used to access the content. The content may be detailed information for using the product regarding the external device 2000. For example, the detailed information may include at least one of a manual of the product, a tutorial video of the product, and product-related information. Also, the content may be a GUI for uploading data about the product regarding the external device 2000.

In operation S552, the mobile device 1000 may send a request for transmitting the content based on the URL received from the server 3000.

In operation S562, the server 3000 may transmit the content to the mobile device 1000.

In operation S572, the mobile device 1000 may display the content received from the server 3000.

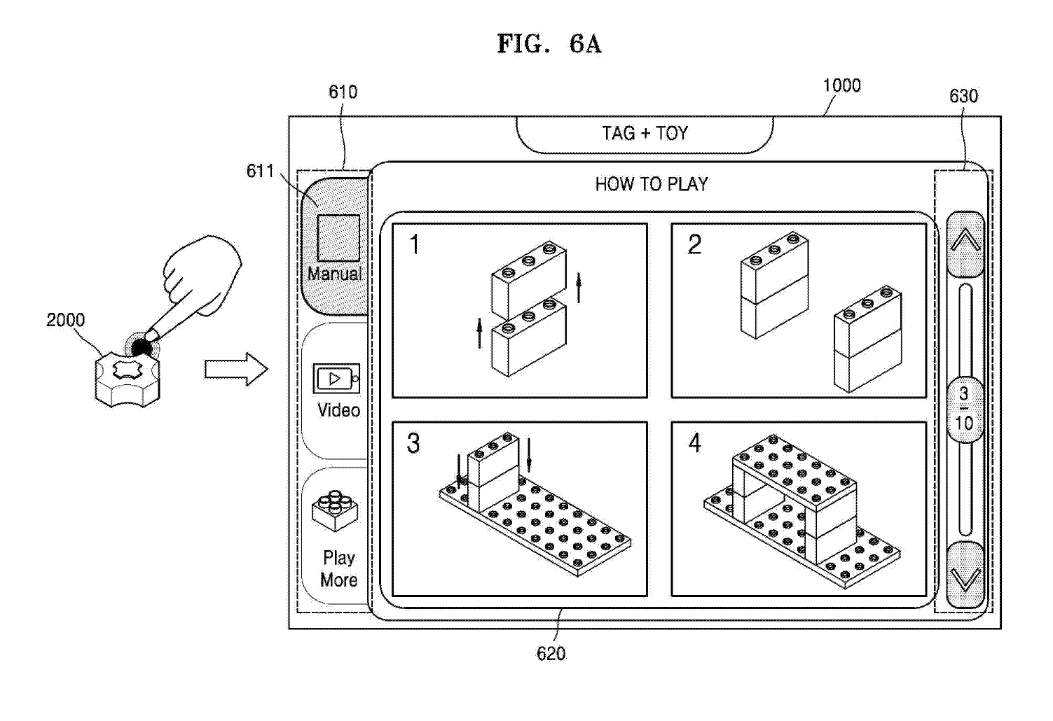

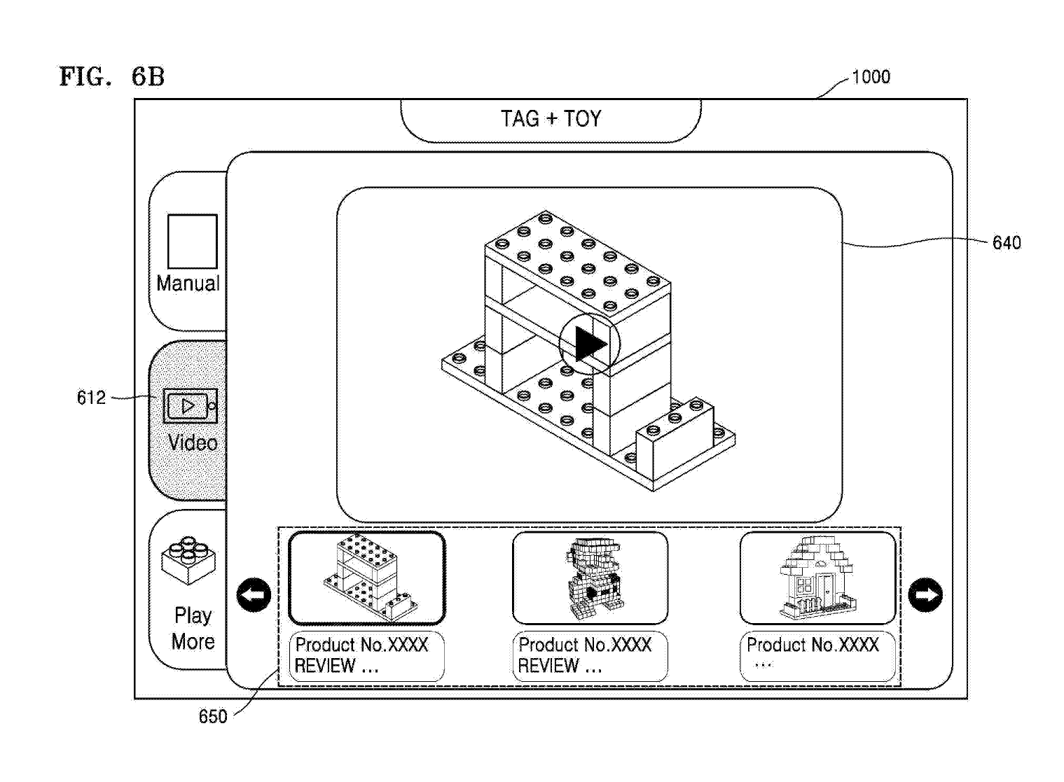

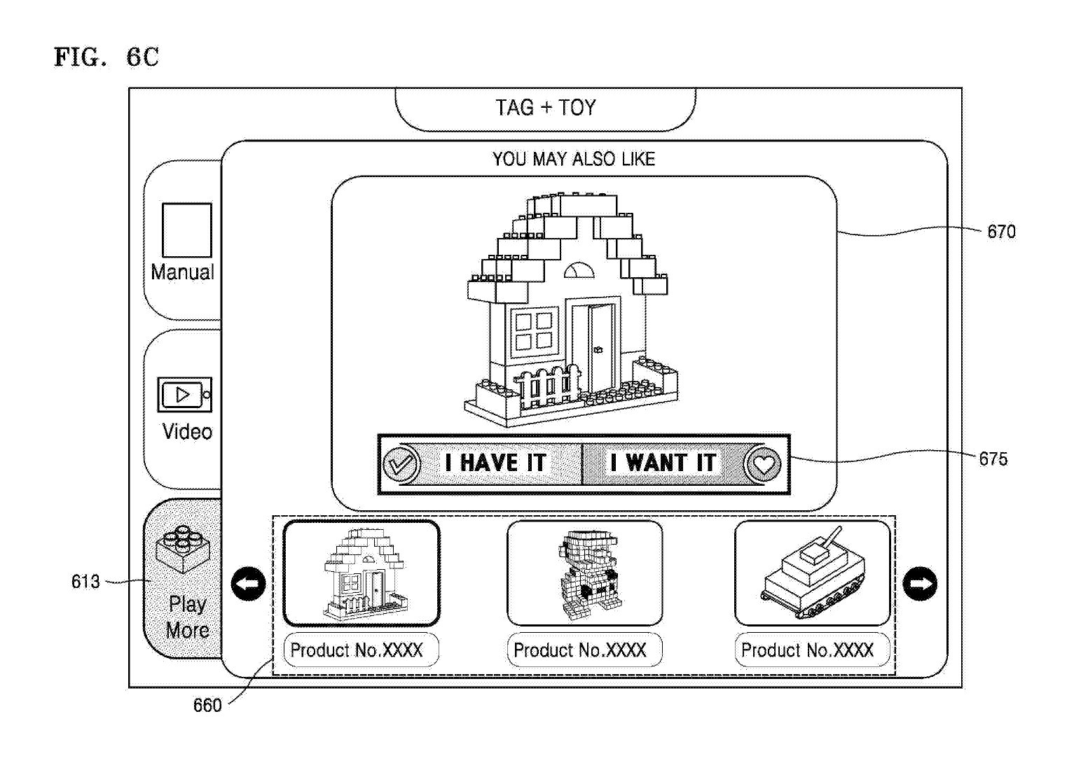

FIGS. 6A to 6C are diagrams of examples of providing content about the external device 2000 when the identifier regarding the user input is the first identifier, according to some embodiments.

For example, when an input of pressing the button on the external device 2000 short is identified, the external device 2000 may transmit, to the mobile device 1000, an identifier regarding the user input as the first identifier. In this case, the mobile device 1000 may receive the detailed information for using the toy 4000 from the server 3000 and may display the detailed information on the screen.

Referring to FIG. 6A, when the identifier regarding the user input is the first identifier, the mobile device 1000 may display a manual 620 of the toy 4000. In this case, a manual menu 611 may be highlighted on a menu tab 610. The manual 620 may include an assembly order of the toy 4000, cautions, etc., but is not limited thereto. Also, the user may move the screen by using a scroll bar 630, but a detailed structure of the screen is not limited thereto.

Referring to FIG. 6B, the mobile device 1000 may display a tutorial video of the toy 4000. In this case, a video menu 612 regarding the tutorial may be highlighted on the menu tab 610. The mobile device 1000 may enlarge a video 640 included in a video list 650 and may display the enlarged video 640 based on a user input. For example, the tutorial video of the toy 4000 may include, but is not limited to, a product introduction video, an assembly method video, a video including user reviews, etc.

Referring to FIG. 6C, the mobile device 1000 may display information about another toy regarding the toy 4000. In this case, a menu 613 showing the information about the other toy may be highlighted on the menu tab 610. In addition, the mobile device 1000 may enlarge an image 670 of a toy, which is selected from a toy list 660 that is related to the toy 4000, and may display the enlarged image 670 based on a user input. Furthermore, the mobile device 1000 may display a GUI 675 for receiving a user input regarding whether the user has other toys regarding the toy 4000 and a user input regarding preference. In this case, the server 3000 may collect, from the mobile device 1000, whether the user has another toy or preference regarding the toy 4000 so as to analyze a certain user pattern.

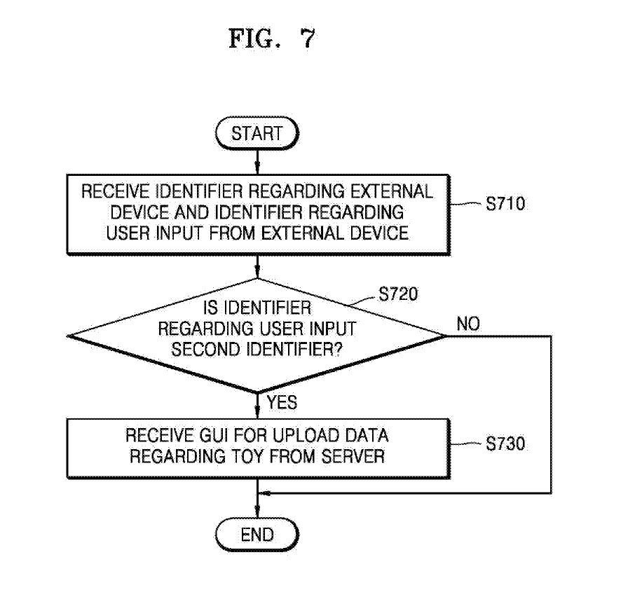

FIG. 7 is a flowchart of a method of receiving, by the mobile device 1000, the content about the external device 2000 when the identifier regarding the user input is the second identifier, according to some embodiments.

In operation S710, the mobile device 1000 may receive the identifier regarding the external device 2000 and the identifier regarding the user input that is input to the external device 2000, from the external device 2000. Since operation S710 corresponds to operation S210 of FIG. 2, detailed descriptions thereof are omitted.

In operation S720, the mobile device 1000 may determine whether the received identifier regarding the user input is the second identifier. For example, the second identifier may be an identifier corresponding to a user input of pressing the button on the external device 2000 long, but is not limited thereto.

When the received identifier regarding the user input is the second identifier according to a determination result obtained in operation S720, the mobile device 1000 may receive a GUI for uploading the data about the toy 4000 from the server 3000 in operation S730. For example, the mobile device 1000 may provide an SNS regarding the toy 4000. The mobile device 1000 may upload the data about the toy 4000 to the server 3000 or receive the data about the toy 4000 from the server 3000 in order to provide the SNS. In this case, the data about the toy 4000 may include an assembly instruction video for the user, user reviews, and grades, but the data is not limited thereto.

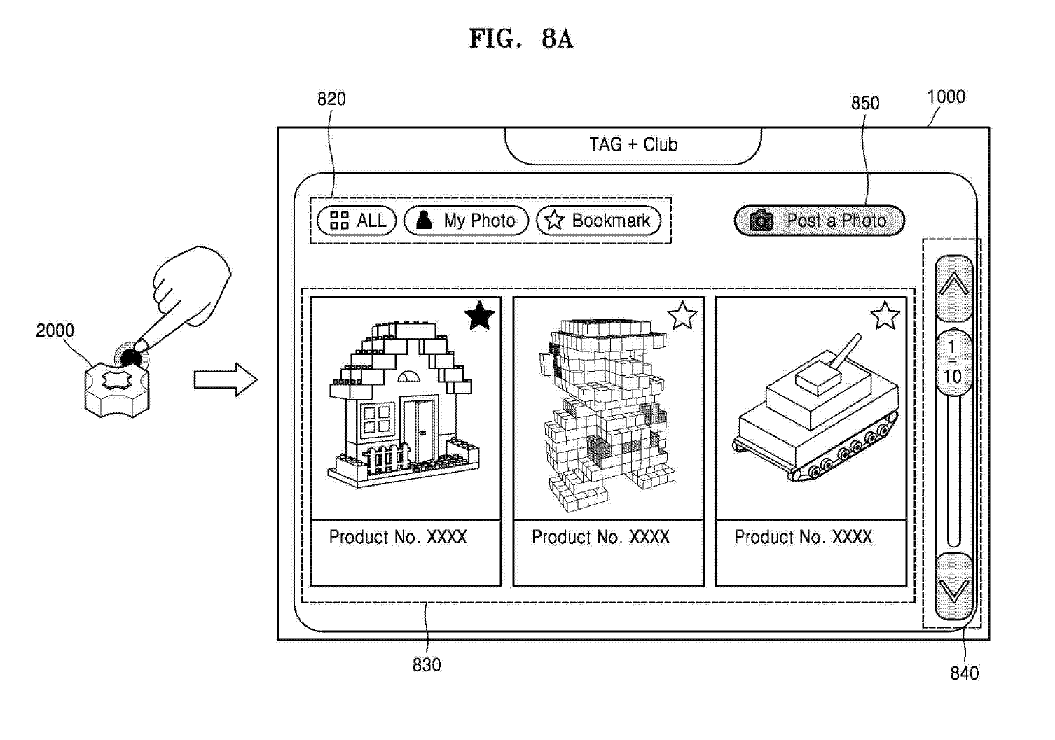

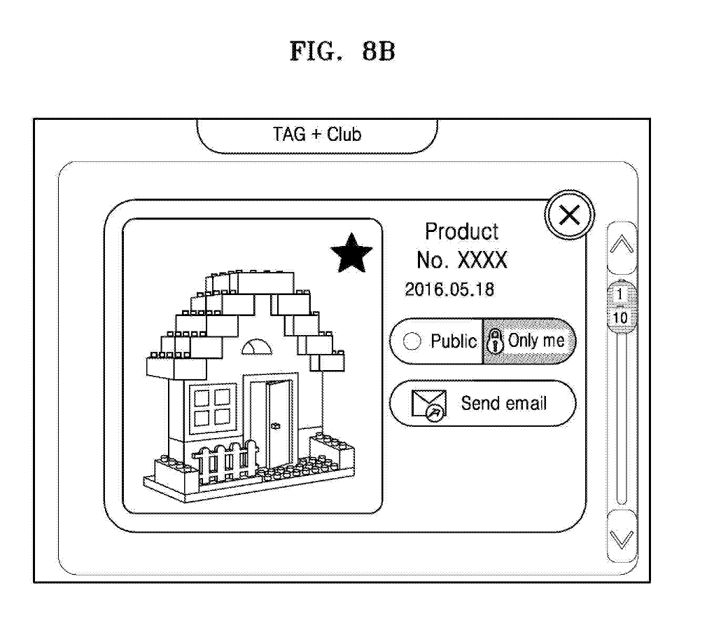

FIGS. 8A and 8B are diagrams of examples of providing the content about the external device 2000 when the identifier regarding the user input is the second identifier, according to some embodiments.

For example, when an input of pressing a button on the external device 2000 long is identified, the external device 2000 may transmit the second identifier as the identifier regarding the user input to the mobile device 1000. In this case, the mobile device 1000 may receive, from the server 3000, the GUI for uploading the data about the toy 4000 and may display the GUI on the screen.

Referring to FIG. 8A, when the identifier regarding the user input is the second identifier, the mobile device 1000 may display a data list 830 regarding the toy 4000 that is uploaded by users. The data list 830 may include images or thumbnails, but is not limited thereto. Since a scroll bar 840 corresponds to the scroll bar 630 of FIG. 6A, detailed descriptions thereof are omitted.

The mobile device 1000 may display a filter mode 820 of the data list 830 regarding the toy 4000. In detail, the filter mode 820 may include a mode of displaying all pieces of data about the toy 4000, a mode of displaying only data that is uploaded by the mobile device 1000, a mode of displaying only data that is set as a bookmark, or the like. However, the filter mode 820 is not limited thereto. In addition, the mobile device 1000 may display an image upload button 850. When the image upload button 850 is pressed, the mobile device 1000 may capture an image and may upload the captured image to the server 3000.

The mobile device 1000 may enlarge one piece of data included in the data list 830 regarding the toy 4000 and may display the enlarged piece of data. Referring to FIG. 8B, the mobile device 1000 may display data about the toy 4000, whether the data is set as a bookmark, whether the data is open to other users, an email sending button, or the like. However, the present disclosure is not limited thereto.

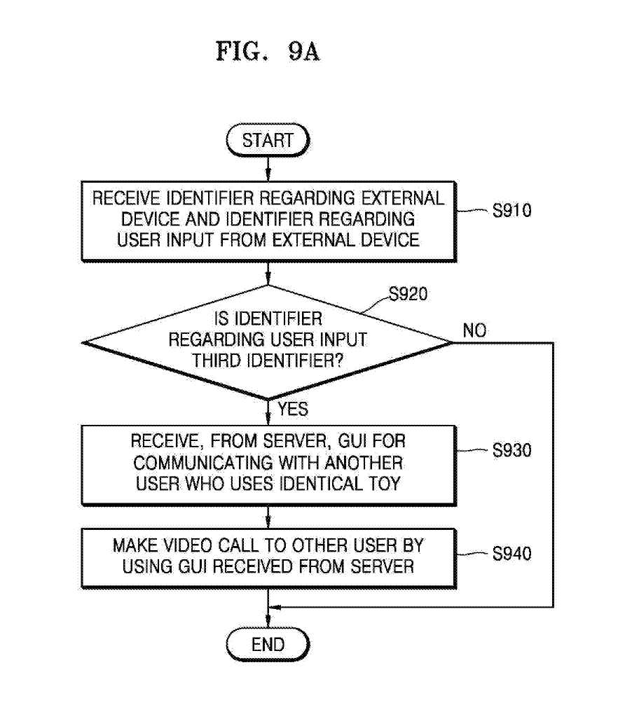

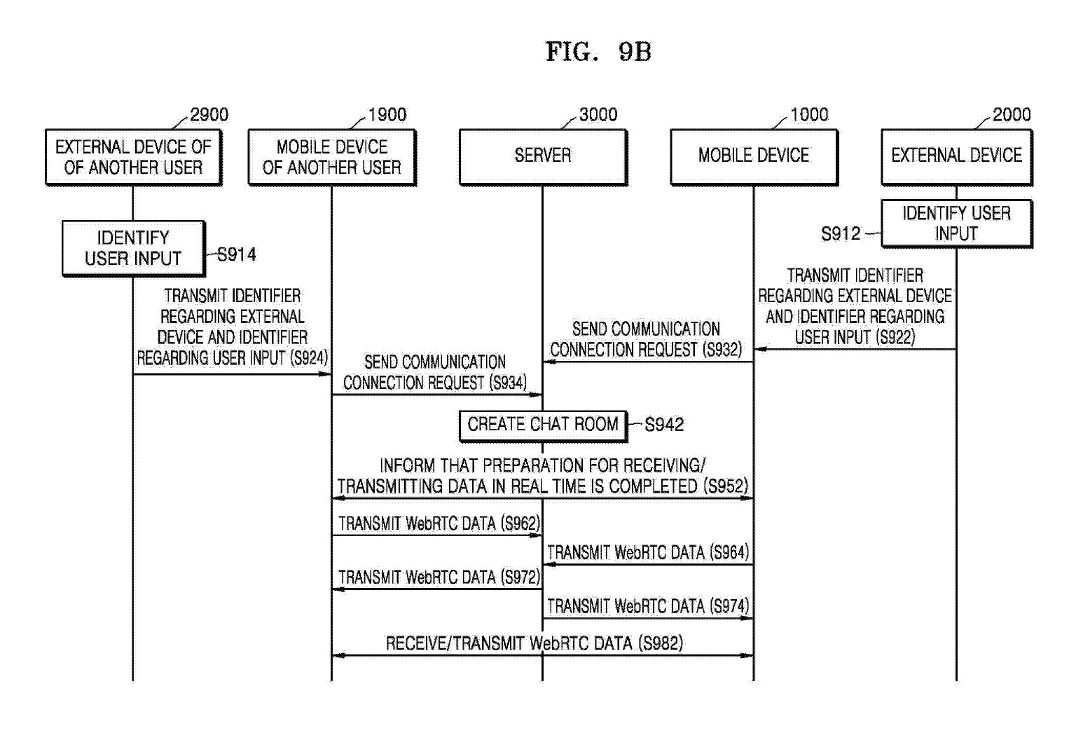

FIG. 9A is a flowchart of a method of receiving, by the mobile device 1000, the content about the external device 2000 when the identifier regarding the user input is the third identifier, according to some embodiments.

In operation S910, the mobile device 1000 may receive, from the external device 2000, the identifier regarding the external device 2000 and the identifier regarding the user input that is input to the external device 2000. Since operation S910 corresponds to operation S210 of FIG. 2, detailed descriptions thereof are omitted.

In operation S920, the mobile device 1000 may determine whether the received identifier regarding the user input is the third identifier. For example, the third identifier may correspond to a user input of shaking the external device 2000, but is not limited thereto.

When the received identifier regarding the user input is the third identifier according to a determination result obtained in operation S920, the mobile device 1000 may receive, from the server 3000, a GUI for communicating with another user who uses a toy 4000 that is identical to the toy 4000, in operation S930.

In operation S940, the mobile device 1000 may make a video call to the other user by using the GUI received from the server 3000.

FIG. 9B is a diagram for explaining a method of receiving, by the mobile device 1000, the content about the external device 2000 when the identifier regarding the user input is the third identifier, according to some embodiments.

In operation S912, the external device 2000 may identify a user input. For example, the external device 2000 may identify a user input of shaking the external device 2000.

In operation S922, the external device 2000 may transmit the identifier regarding the external device 2000 and the identifier regarding the user input to the mobile device 1000. For example, when the user input of shaking the external device 2000 is identified, the external device 2000 may transmit the identifier regarding the user input to the third identifier.

In operation S932, the mobile device 1000 may send a communication connection request to the server 3000. When the communication connection request is sent, the mobile device 1000 may transmit the identifier regarding the external device 2000 and the identifier regarding the user input to the server 3000.

Since operations S914, S924, and S934 respectively correspond to operations S912, S922, and S932, detailed descriptions thereof are omitted.

In operation S942, the server 3000 may create a chat room so as to exchange data in real-time with a mobile device 1900 of another user which transmits an identifier regarding an external device, the identifier being identical to the identifier regarding the external device 2000 and being transmitted by the mobile device 1000.

In operation S952, the server 3000 may inform that preparation for receiving/transmitting data to the mobile device 1000 and the mobile device 1900 in real time is completed.

In operation S962, the mobile device 1900 may transmit Web Real-Time Communication (WebRTC) data to the server 3000. The WebRTC data may be data according to communication protocols and standards regarding application programming interfaces that enable real-time communication. That is, the mobile device 1900 may transmit texts, voices, images, etc. in real time by using a WebRTC data form.

In operation S972, the server 3000 may transmit the WebRTC data received from the mobile device 1000, to the mobile device 1900.

Since operations S964 and S974 respectively correspond to operations S962 and S972, detailed descriptions thereof are omitted.

In operation S982, the mobile device 1000 and the mobile device 1900 may directly receive/transmit the WebRTC data. For example, the mobile device 1000 and the mobile device 1900 may receive/transmit the WebRTC data via a Traversal Using Relay NAT (TURN) server and thus may make a video call.

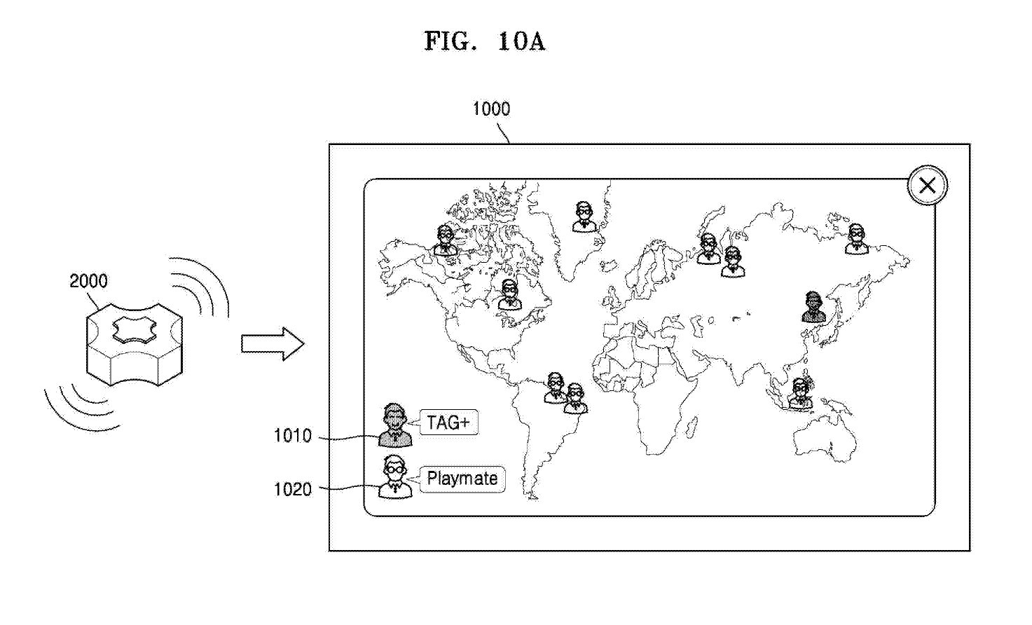

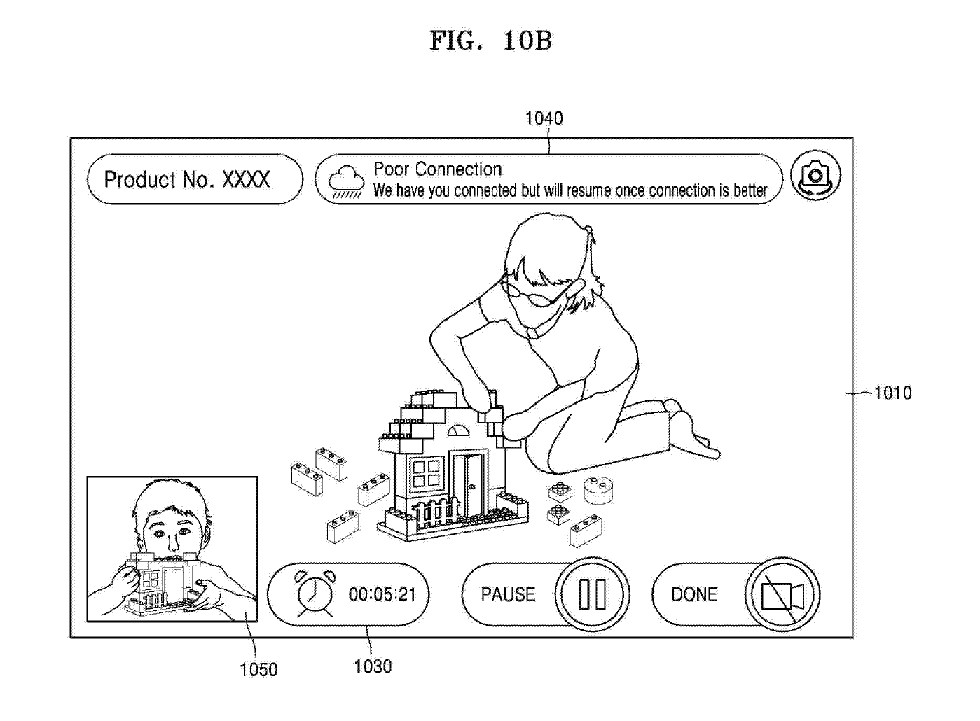

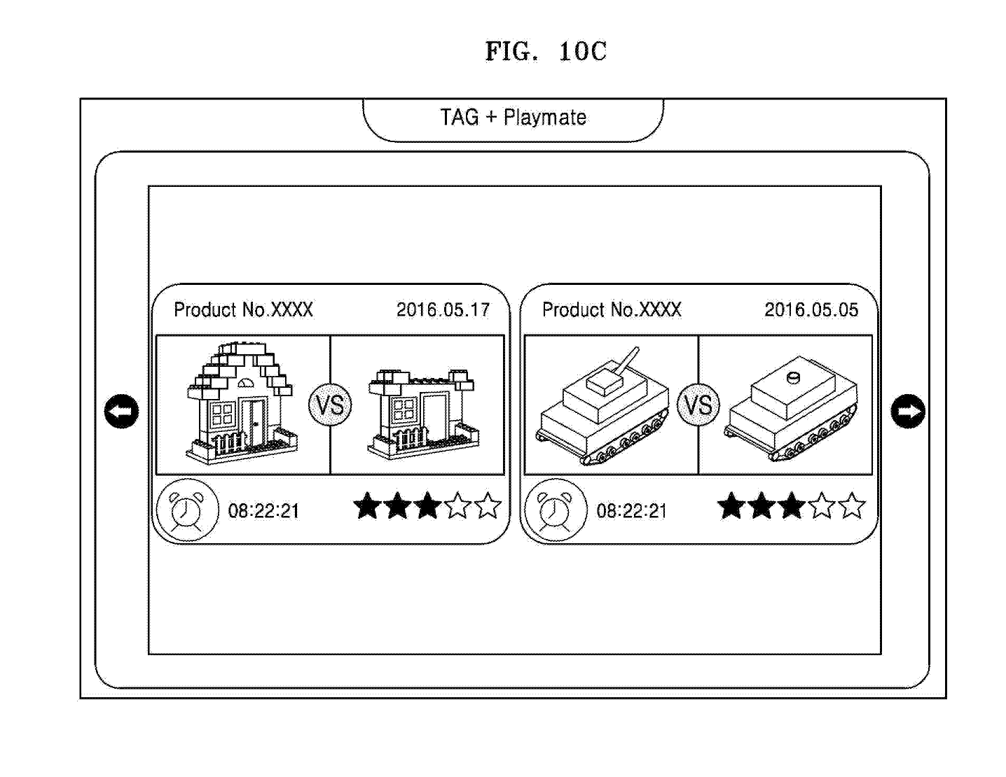

FIGS. 10A to 10C are diagrams of examples of providing the content about the external device 2000 when the identifier regarding the user input is the third identifier, according to some embodiments.

For example, when the input of shaking the external device 2000 is identified, the external device 2000 may transmit, to the mobile device 1000, the third identifier as the identifier regarding the user input. In this case, the mobile device 1000 may receive, from the server 3000, the GUI for communicating with the other user who uses the toy 4000 that is identical to the toy 4000, and may display the GUI on the screen.

Referring to FIG. 10A, when the identifier regarding the user input is the third identifier, the mobile device 1000 may display a first emoticon 1010 at a location corresponding to a location of the mobile device 1000. In addition, second emoticons 1020 may be displayed at locations corresponding to locations of other users who use the toys 4000 that are identical to the toy 4000.

Also, when one of the second emoticons 1020 is selected by the user, the mobile device 1000 may send a video call request to a user corresponding to the selected second emoticon 1020. Also, the mobile device 1000 may receive a video call from another user.

For example, referring to FIG. 10B, the mobile device 1000 may make a video call to another user. In this case, an image 1010 captured by the other user and an image 1050 captured by the mobile device 1000 may be displayed, but locations of the images 1010 and 1050 are not limited. In addition, the mobile device 1000 may provide a stopwatch 1030 and communication status information 1040 which are used when two users, who talk to each other on the video phone, play.

Referring to FIG. 10C, after the video call ends, the mobile device 1000 may display a GUI for managing a video call review by using snapshots obtained during the video call. For example, the mobile device 1000 may display snapshots showing assembly of a house, the snapshots being obtained during a video call made on May 17, 2016. In this case, time information obtained by the stopwatch 1030, a grade input by the users, etc. may be displayed.

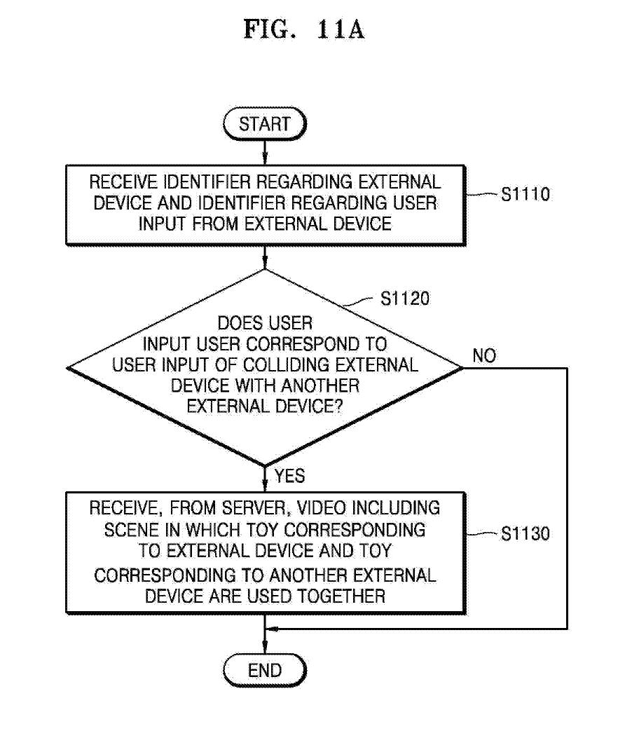

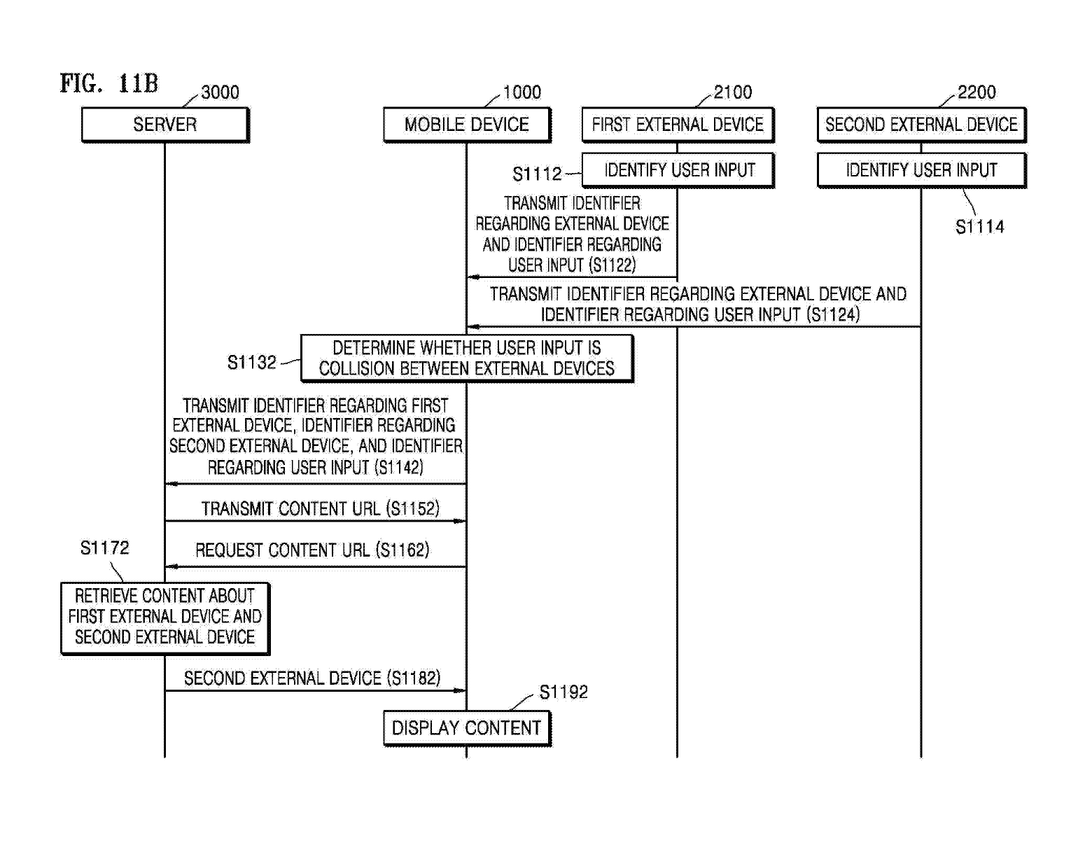

FIG. 11A is a flowchart of a method of receiving, by the mobile device 1000, the content about the external device 2000 when the identifier regarding the user input is an identifier indicating a collision between external devices, according to some embodiments.

In operation S1110, the mobile device 1000 may receive, from the external device 2000, the identifier regarding the external device 2000 and the identifier regarding the user input that is input to the external device 2000. Operation S1110 corresponds to operation S210 of FIG. 2, and detailed descriptions thereof are omitted.

In operation S1120, the mobile device 1000 may determine whether the user input is a user input of colliding the external device 2000 with another external device 2000. For example, when an identifier regarding a user input corresponding to an input of shaking for a certain time period, is received from the external devices 2000, the mobile device 1000 may determine that the user input indicates the collision between the external devices. However, a method of determining a user input as a collision between external devices is not limited thereto.

When the identifier regarding the user input is the identifier indicating the collision between the external devices according to a determination result obtained in operation S1120, the mobile device 1000 may receive, from the server 3000, a video including a scene in which two toys 4000 are used together, in operation S1130.

FIG. 11 B is a diagram for explaining a method of receiving, by the mobile device 1000, the content about a first external device 2100 and a second external device 2200 when the identifier regarding the user input is the identifier indicating the collision between the first and second external devices 2100 and 2200, according to some embodiments.

In operation S1112, the first external device 2100 may identify a user input. For example, the first external device 2100 may identify a user input of shaking the first external device 2100.

In operation S1122, the first external device 2100 may transmit the identifier regarding the first external device 2100 and the identifier regarding the user input to the mobile device 1000.

Since operations S1114 and S1124 respectively correspond to operations S1112 and S1122, detailed descriptions thereof are omitted.

In operation S1132, the mobile device 1000 may determine whether the user input is generated due to a collision between the first and second external devices 2100, 2200, based on identifiers regarding user inputs received from the first external device 2100 and the second external device 2200. For example, when an identifier regarding a user input corresponding to an input of shaking for a certain time period, is received from the first external device 2100 and the second external device 2200, the mobile device 1000 may determine that the user input is generated by the collision between the first and second external devices 2100 and 2200.

In operation S1142, the mobile device 1000 may transmit an identifier regarding the first external device 2100, an identifier regarding the second external device 2200, and the identifier regarding the user input to the server 3000.

Since operations S1152 and S1162 respectively correspond to operations S542 and S552 of FIG. 5B, detailed descriptions thereof are omitted.

In operation S1172, the server 3000 may retrieve content about the first external device 2100 and the second external device 2200 by using the identifier regarding the first external device 2100 and the identifier regarding the second external device 2200 which are received from the mobile device 1000.

In operation S1182, the server 3000 may transmit the retrieved content to the mobile device 1000.

In operation S1192, the mobile device 1000 may display the content transmitted from the server 3000.

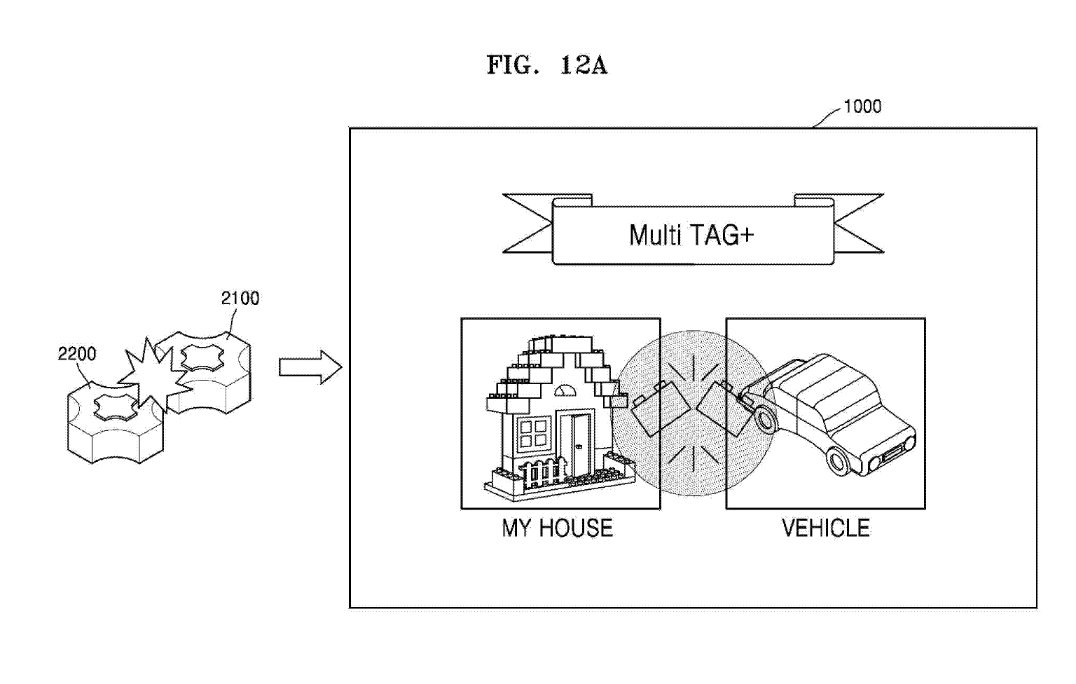

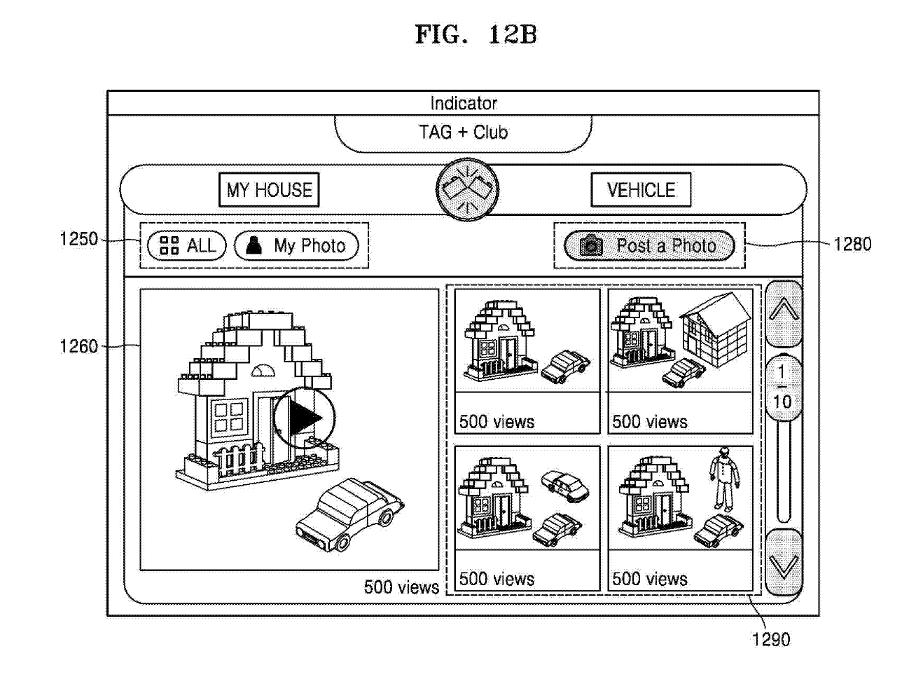

FIGS. 12A and 12B are diagrams of examples of providing the content about the external device 2000 when the identifier regarding the user input is the identifier indicating the collision between the external devices, that is, the first and second external devices 2100 and 2200, according to some embodiments.

For example, referring to FIG. 12A, when the first external device 2100 collides with the second external device 2200, the mobile device 1000 may display that the user input is determined as the collision between the first external device 2100 and the second external device 2200. In this case, a toy, which corresponds to the first external device 2100 and is assembled as a house, and a toy, which corresponds to the second external device 2200 and is assembled as a vehicle, may be displayed together.

Referring to FIG. 12B, the mobile device 1000 may display a video 1260 including a scene in which the toy assembled as the house and the toy assembled as the vehicle are used together. Also, a data list 1290 regarding the toys may be displayed. The data list 1290 may include images or thumbnails, but is not limited thereto. Since a filter mode 1250 and an image upload button 1280 of FIG. 12B respectively correspond to the filter mode 820 and the image upload button 850 of FIG. 8A, detailed descriptions thereof are omitted.

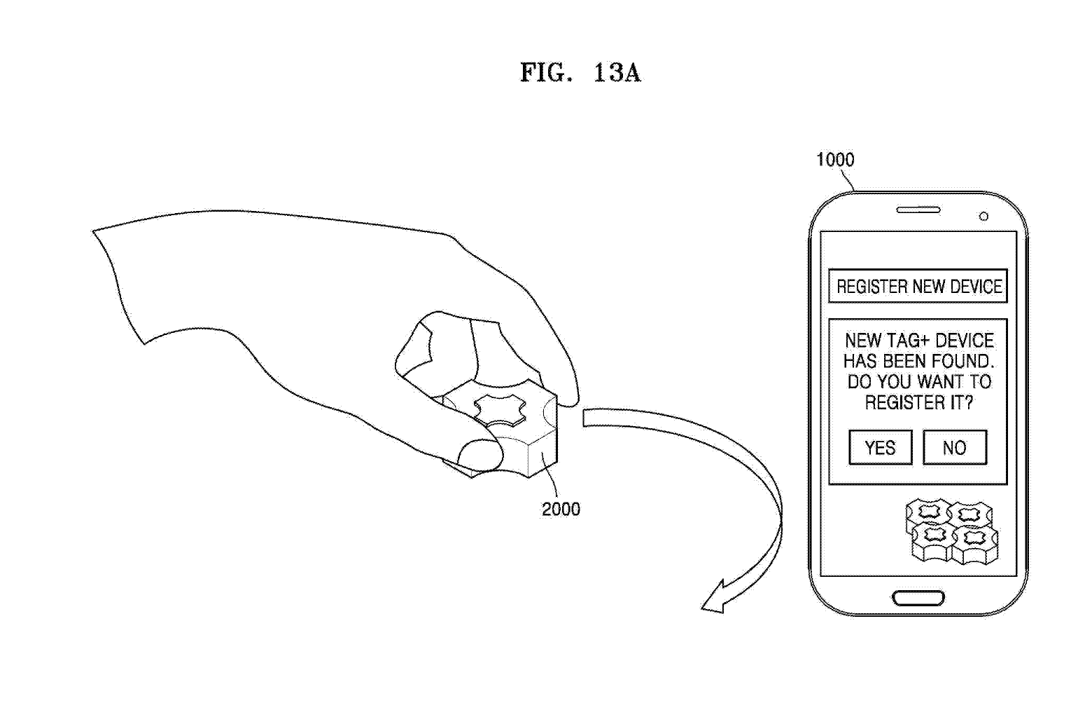

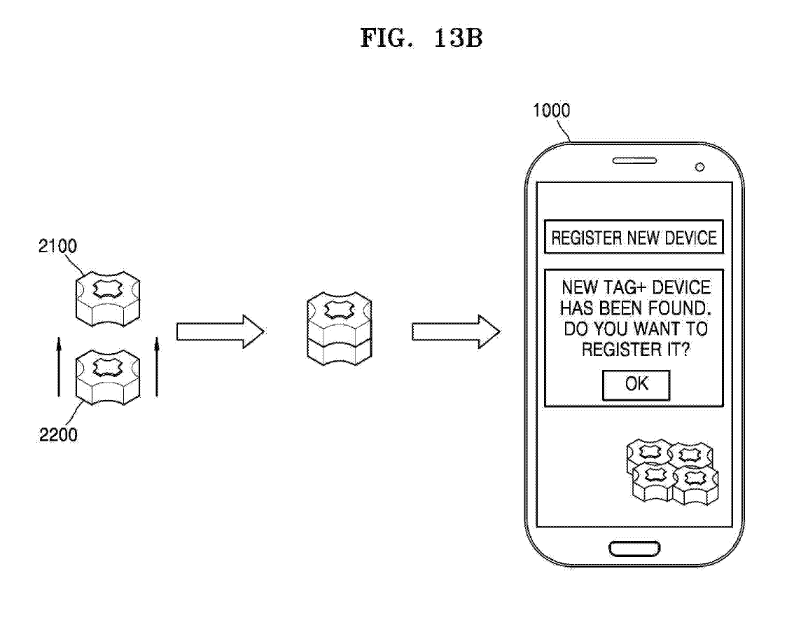

FIGS. 13A and 13B are diagrams of examples of registering the external device 2000 by the mobile device 1000, according to some embodiments.

The mobile device 1000 may register the external device 2000 based on the identifier regarding the user input that is input to the external device 2000, without an initial setting regarding the external device 2000.

For example, referring to FIG. 13A, when an input of moving the external device 2000 in a circle is identified, the external device 2000 may transmit an identifier regarding the input to the mobile device 1000. When the identifier regarding the user input is received from the external device 2000, the mobile device 1000 may display that the external device 2000 has been registered. In this case, the mobile device 1000 may allow the server 3000 to renew a user profile by transmitting the identifier regarding the external device 2000 to the server 3000.

Referring to FIG. 13B, in response to coupling the first external device 2100, which is already registered, to a new second external device 2200, the mobile device 1000 may register the second external device 2200. In this case, the mobile device 1000 may receive a different identifier regarding the user input according to a location where the first external device 2100 is coupled to the second external device 2200. When the first external device 2100 and the second external device 2200 are coupled, the identifier regarding the second external device 2200 or information about a product regarding the second external device 2200 may be transmitted to the first external device 2100 in a wired or wireless manner.

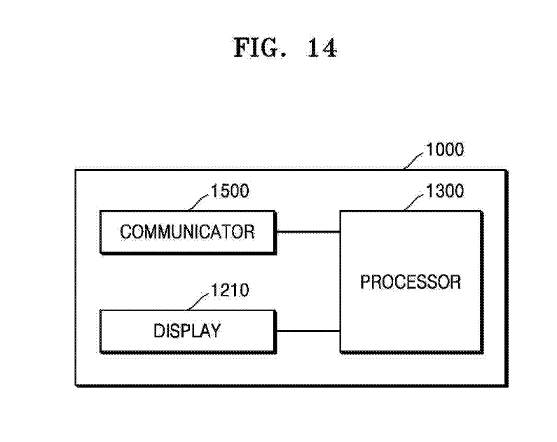

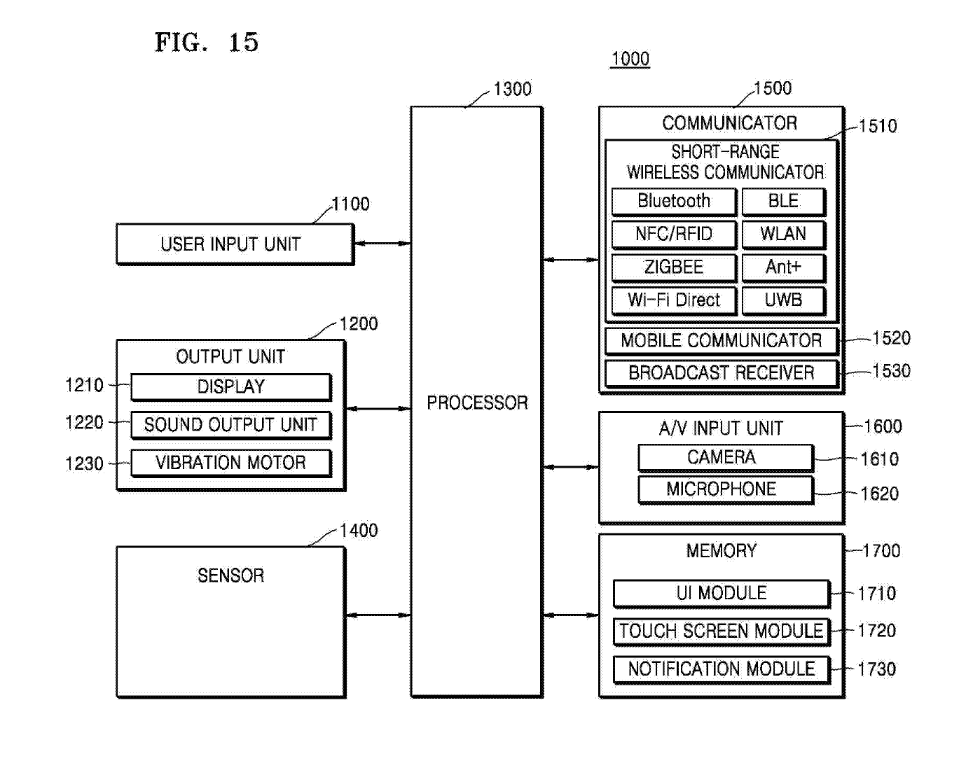

FIGS. 14 and 15 are block diagrams of the mobile device 1000 according to some embodiments.

As shown in FIG. 14, the mobile device 1000 according to some embodiments may include a display 1210, the communicator 1500, and a processor 1300. However, not every component shown in FIG. 14 is necessary. The mobile device 1000 may be embodied by more or less components than the components shown in FIG. 14.

For example, as shown in FIG. 15, the mobile device 1000 according to some embodiments may further include a user input unit 1100, an output unit 1200, a sensor 1400, an audio/video (A/V) input unit 1600, and a memory 1700 in addition to the display 1210, the communicator 1500, and the processor 1300.

The user input unit 1100 may be a unit by which a user inputs data to control the memory 1700. For example, the user input unit 1100 may include a key pad, a dome switch, a touch pad (a touch capacitive type touch pad, a pressure resistive type touch pad, an infrared beam sensing type touch pad, a surface acoustic wave type touch pad, an integral strain gauge type touch pad, a Piezo effect type touch pad, or the like), a jog wheel, and a jog switch, but one or more embodiments are not limited thereto.

The output unit 1200 may output an audio signal, a video signal, or a vibration signal and may include the display 1210, a sound output unit 1220, a vibration motor 1230, or the like.

The display 1210 displays and outputs information that is processed in the mobile device 1000. For example, the display 1210 may display content received from the server 3000.

The sound output unit 1220 outputs audio data that is received from the communicator 1500 or is stored in the memory 1700.

The processor 1300 may generally control all operations of the mobile device 1000. For example, the processor 1300 may generally control the user input unit 1100, the output unit 1200, the sensor 1400, the communicator 1500, the A/V input unit 1600, etc. by executing programs stored in the memory 1700. Also, the processor 1300 may perform the functions of the mobile device 1000, which are described with reference to FIGS. 1 to 13B, by executing the programs stored in the memory 1700.

The processor 1300 may receive/transmit data from/to the external device 2000 and the server 3000 through the communicator 1500. When receiving the content about the external device 2000 from the server 3000, the processor 1300 may execute an application for displaying the received content. In this case, the received content may be selected based on the identifier regarding the external device 2000 and the identifier regarding the user input that is input to the external device 2000. Also, the received content may be received from the server 3000 in order to provide the SNS. Also, the received content may be determined by the server 3000 based on information about the product regarding the external device 2000. In this case, the information may include at least one of a model name, a serial number, a manufacture number, and a product number of the product.

The content about the external device 2000 may include at least one of detail information for using the product regarding the external device 2000, the GUI for uploading the data about the product regarding the external device 2000, the GUI for communicating with another user who uses a product that is identical to the product regarding the external device 2000, and a video including a scene in which respective products regarding the external devices 2000 are used together. However, the content is not limited thereto. In addition, the detail information may include at least one of a manual of the product, a tutorial video of the product, and information about other products regarding the product.

The identifier regarding the user input may indicate at least one of a button input, a touch input, and a motion input. For example, the user input identified by the external device 2000 may include at least one of an input of pressing the button on the external device 2000 short, an input of pressing the button long, an input corresponding to a motion of shaking the external device 2000, and an input of colliding two external devices 2000. However, the user input is not limited thereto.

The sensor 1400 may detect a state of the mobile device 1000 or a state around the mobile device 1000 and may transmit detected information to the processor 1300.

The communicator 1500 may include one or more components for communication between the mobile device 1000 and the external device 2000, the server 3000, and another device (not shown). The other device (not shown) may be a computing device such as the mobile device 1000 or a sensing device other than the external device 2000. However, one or more embodiments are not limited thereto. For example, the communicator 1500 may include a short-range wireless communicator 1510, a mobile communicator 1520, and a broadcast receiver 1530.

The short-range wireless communicator 1510 may include a Bluetooth communicator, a BLE communicator, an NFC communicator, a WLAN communicator, a Zigbee communicator, an IrDA communicator, a WFD communicator, a UWB communicator, an Ant+ communicator, or the like. However, the present disclosure is not limited thereto.

The mobile communicator 1520 may receive/transmit a wireless signal from/to at least one of a broadcast station, an external terminal, and the server 3000 via a wireless communication network. The wireless signal may include various types of data according to reception/transmission of a voice call signal, a video-call call signal, or a text message/multimedia message.

The broadcast receiver 1530 receives a broadcast signal and/or broadcast-related information from the outside through a broadcast channel. The broadcast channel may include a satellite channel and a terrestrial channel. According to an embodiment, the mobile device 1000 may not include the broadcast receiver 1530.

In addition, the communicator 1500 may receive, from the external device 2000, the identifier regarding the external device 2000 and the identifier regarding the user input that is input to the external device 2000. The communicator 1500 may transmit the identifier regarding the external device 2000 and the identifier regarding the user input to the server 3000 and may receive the content about the external device 2000 from the server 3000.

The A/V input unit 1600 is used to input an audio signal or a video signal and may include a camera 1610, a microphone 1620, and the like. The camera 1610 may obtain an image frame such as a still image or a moving image by using an image sensor in a video call mode or a photographing mode. An image captured by the image sensor may be processed by the processor 1300 or a separate image processor (not shown).

The microphone 1620 may convert a received external audio signal into electrical voice data. For example, the microphone 1620 may receive an audio signal from an external device or a speaker. The microphone 1620 may receive an audio input of the user. The microphone 1620 may use various noise removal algorithms for removing noise generated during the receiving of the external audio signal.

The memory 1700 may store programs to process and control the processor 1100 or may store data input to or output from the mobile device 1000.

The memory 1700 may include at least one storage medium from among a flash memory-type storage medium, a hard disk-type storage medium, a multimedia card micro-type storage medium, card-type memories (e.g., a secure digital (SD) card, an extreme digital (XD) memory, and the like), a Random Access Memory (RAM), a Static Random Access Memory (SRAM), a Read-Only Memory (ROM), an Electrically Erasable Programmable Read-Only Memory (EEPROM), a Programmable Read-Only Memory (PROM) magnetic memory, a magnetic memory, a magnetic disc, and an optical disc.

The programs stored in the memory 1700 may be classified into modules, for example, a user interface (UI) module 1710, a touch screen module 1720, and a notification module 1730, according to their functions.

The UI module 1710 may provide a specialized UI or GUI which interoperates with the mobile device 1000 according to applications. The touch screen module 1720 may detect a user's touch gesture on a touch screen and may transmit information about the touch gesture to the processor 1300. The touch screen module 1720 according to some embodiments may recognize and analyze touch codes. The touch screen module 1720 may be configured as separate hardware including a controller.

The notification module 1730 may generate a signal for notifying the occurrence of events in the mobile device 1000. Examples of events occurring in the mobile device 1000 may be reception of a call signal, reception of a message, a key signal input, a schedule notification, and the like.

In some embodiments, a device for receiving and displaying content about the external device 2000 is defined as the mobile device 1000, but may be a non-mobile device. The non-mobile device may be a digital broadcasting terminal, a navigation device, a kiosk, a home appliance, or other non-mobile computing devices, but one or more embodiments are not limited thereto. Moreover, a mobile device and a non-mobile device may include all types of devices that are capable of receiving, from the external device 2000, the identifier regarding the user input that is input to the external device 2000, transmitting the identifier to the server 3000, receiving the content about the external device 2000 from the server 3000, and providing the received content.

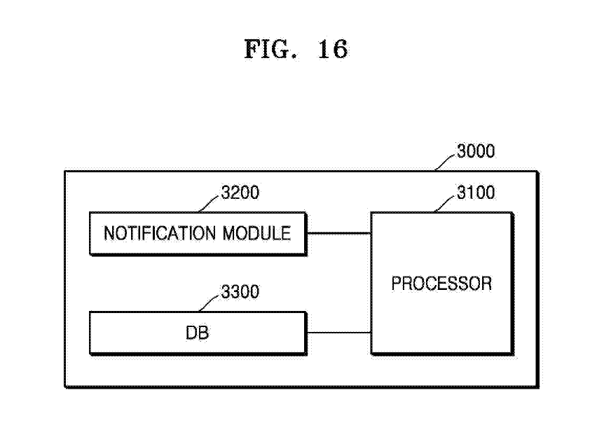

FIG. 16 is a block diagram of the server 3000 according to some embodiments.

Referring to FIG. 16, the server 3000 according to some embodiments may include a communicator 3200, a database (DB) 3300, and a processor 3100.

The communicator 3200 may include one or more components for communicating with the mobile device 100 and other devices (not shown).

The DB 3300 may store data used to select the content about the external device 2000.

The processor 3100 may generally control all operations of the mobile device 1000. For example, the processor 3100 may generally control the DB 3300, the communicator 3200, etc. by executing programs stored in the DB 3300 of the server 3000. The processor 3100 may perform some of the operations of the server 3000, which are described with reference to FIGS. 1 to 13B, by executing the programs stored in the DB 3300.

The processor 3100 may select content to be transmitted to the mobile device 1000, based on the identifier regarding the external device 2000 and the identifier regarding the user input that is input to the external device 2000.

Also, the processor 3100 may produce and manage a user profile by using the identifier regarding the mobile device 1000 and the identifier regarding the external device 2000, which are received from the mobile device 1000.

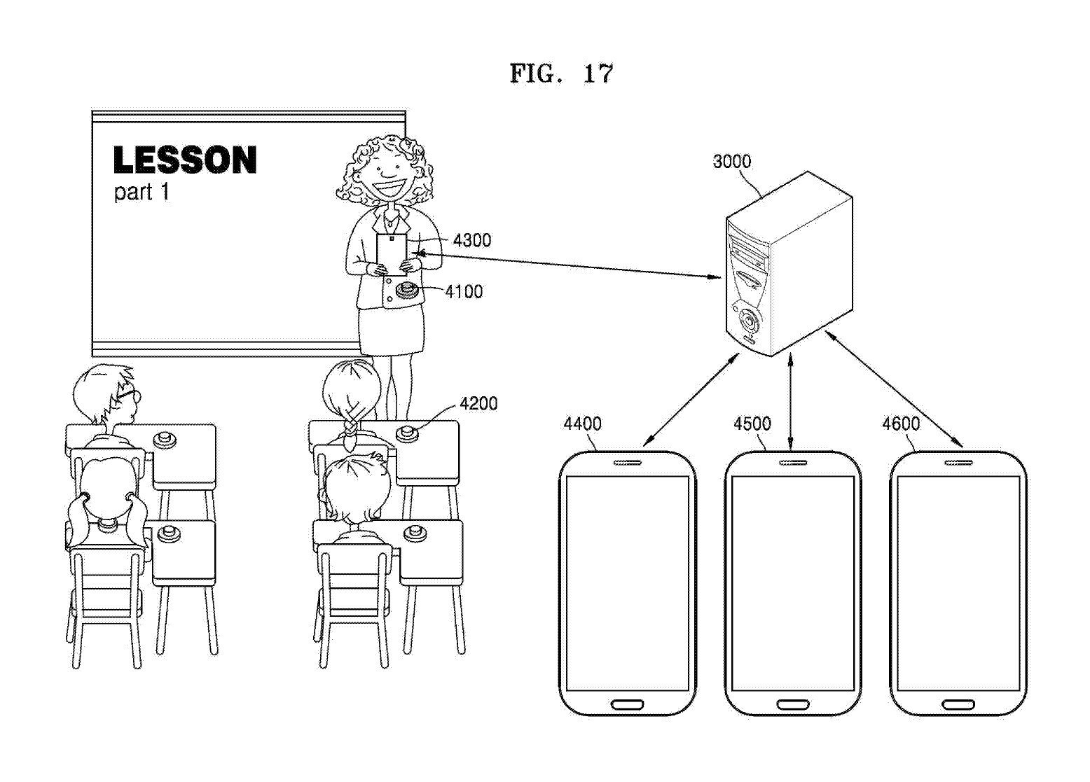

FIG. 17 is a diagram of a system for providing class-related content by using information received from external devices, according to some embodiments.

According to an embodiment, the system for providing the class-related content may include a third external device 4100 corresponding to a teacher who is giving lessons, a fourth external device 4200 corresponding to each student who attends the class, a hub device 4300, and a server 3000. However, the components of the system are not limited thereto. There may be one or more fourth external devices 4200, and the number of fourth external devices 4200 may differ according to the number of students who attend the class.

According to an embodiment, the hub device 4300 may be a fixed or portable electronic device that the teacher uses to provide lessons to the students. For example, the hub device 4300 may be, but is not limited to, a smart phone, a tablet PC, a mobile phone, a PDA, a laptop computer, a desktop, a media player, or another computing device. The structure of the hub device 4300 may correspond to that of the mobile device 1000 of FIGS. 14 and 15.

According to an embodiment, the hub device 4300 may be connected to multiple external devices. For example, the hub device 4300 may form a wireless communication link with the third external device 4100, which corresponds to the teacher who is giving the lessons, and the fourth external device 4200 corresponding to each student who attends the class. In this case, the hub device 4300 may receive an identifier regarding a user input from the third external device 4100 and/or the fourth external device 4200 and an identifier regarding the third external device 4100 and/or the fourth external device 4200 via the wireless communication link. Also, the hub device 4300 may output the class-related content and thus may provide the class-related content to the teacher, based on the identifier regarding the user input from the third external device 4100 and/or the fourth external device 4200 and the identifier regarding the third external device 4100 and/or the fourth external device 4200.

Here, the class-related content may include at least one of content regarding students who attend the class, content regarding students who understand the class, content regarding feedbacks from students on the class, content regarding students who need help during the class, and content regarding students who get praised by the teacher during the class. However, the class-related content is not limited thereto.

According to an embodiment, the hub device 4300 is connected to the server 3000 and thus may receive/transmit data from/to the server 3000. For example, the hub device 4300 may transmit the class-related content to the server 3000.

According to an embodiment, the server 3000 may provide mobile devices with the content-related content that is received from the hub device 4300. For example, the server 3000 may provide the class-related content to a mobile device 4400 of a student's parent. In addition, the server 3000 may provide content regarding feedbacks on the class to a mobile device 4500 of the teacher or a mobile device 4600 of a head teacher.

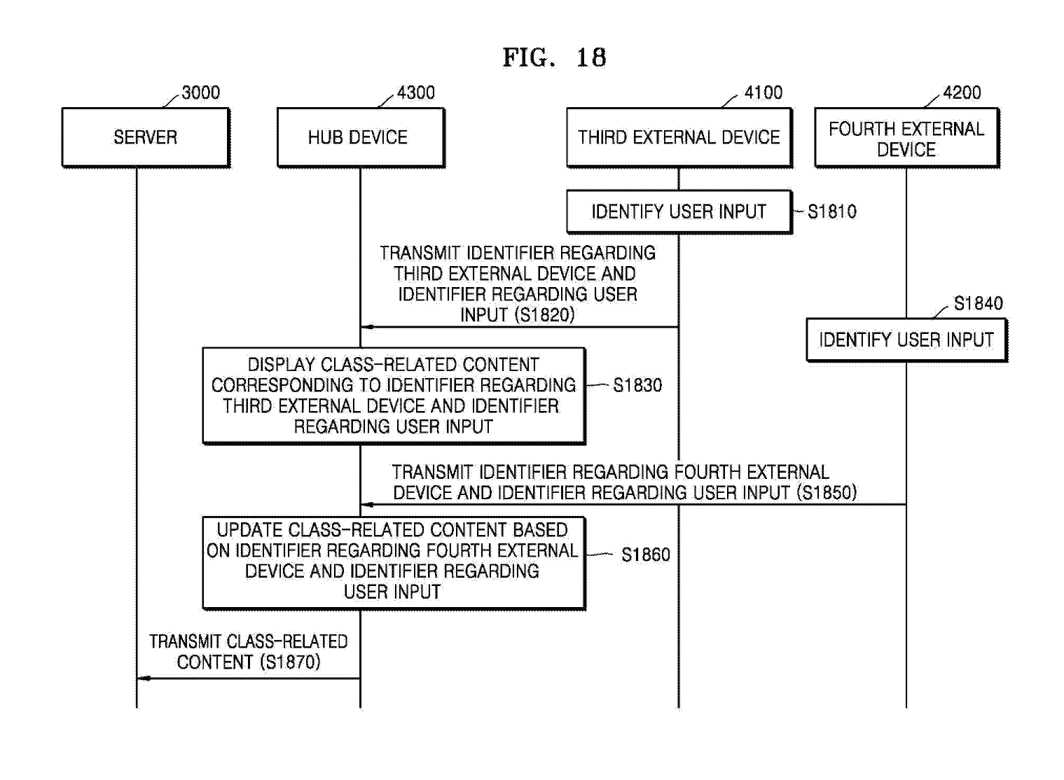

FIG. 18 is a flowchart of a method of displaying, by the hub device 4300, class-related content, according to some embodiments.

In operation S1810, the third external device 4100 may identify a user input. For example, the third external device 4100 may identify an input of pressing, by the teacher who is a user, a certain button on the third external device 4100 short for less than a certain time period (e.g., 3 seconds) or long for greater than the certain time period (e.g., 3 seconds), an input of pressing, by the teacher, the button a certain number of times (e.g., twice), or an input of shaking the third external device 4100.

In operation S1820, the third external device 4100 may transmit, to the hub device 4300, an identifier regarding the third external device 4100 and an identifier regarding a user input.

In operation S1830, the hub device 4300 may display the class-related content corresponding to the received identifiers regarding the third external device 4100 and the user input. For example, when an identifier regarding the input of shaking the third external device 4100 is received from the third external device 4100, the hub device 4300 may activate an application regarding the class and may display a subject list on a screen. Also, when an identifier regarding the input of pressing, by the teacher, the button on the third external device 4100 short is received from the third external device 4100, the hub device 4300 may display, on the screen, a GUI for inducing the students to send a user input by using the fourth external device 4200.

In operation S1840, the fourth external device 4200 may identify a user input. For example, the fourth external device 4200 may identify an input of pressing, by a student who is a user, a certain button on the fourth external device 4200 short for less than a certain time period (e.g., 3 seconds) or long for greater than the certain time period (e.g., 3 seconds), an input of pressing, by the student, the button a certain number of times (e.g., twice), or an input of shaking the fourth external device 4200.

In operation S1850, the fourth external device 4200 may transmit an identifier regarding the fourth external device 4200 and an identifier regarding a user input to the hub device 4300.

In operation S1860, the hub device 4300 may update the class-related content based on the received identifiers regarding the fourth external device 4200 and the user input. For example, after the hub device 4300 displays, on a screen, a GUI for inducing the students to send user inputs by using the fourth external devices 4200, identifiers regarding the inputs of pressing the buttons on the fourth external devices 4200 short may be received. In this case, the hub device 4300 may display, on the screen, the number of fourth external devices 4200, which transmit the identifiers regarding the inputs of pressing the buttons short, as the number of students who understand the class.

In operation S1870, the hub device 4300 may transmit the class-related content to the server 3000. For example, the hub device 4300 may transmit, to the server 3000, at least one of content regarding students who attend the class, content regarding students who understand the class, content regarding feedbacks from students on the class, content regarding students who need help during the class, and content regarding students who get praised by the teacher during the class.

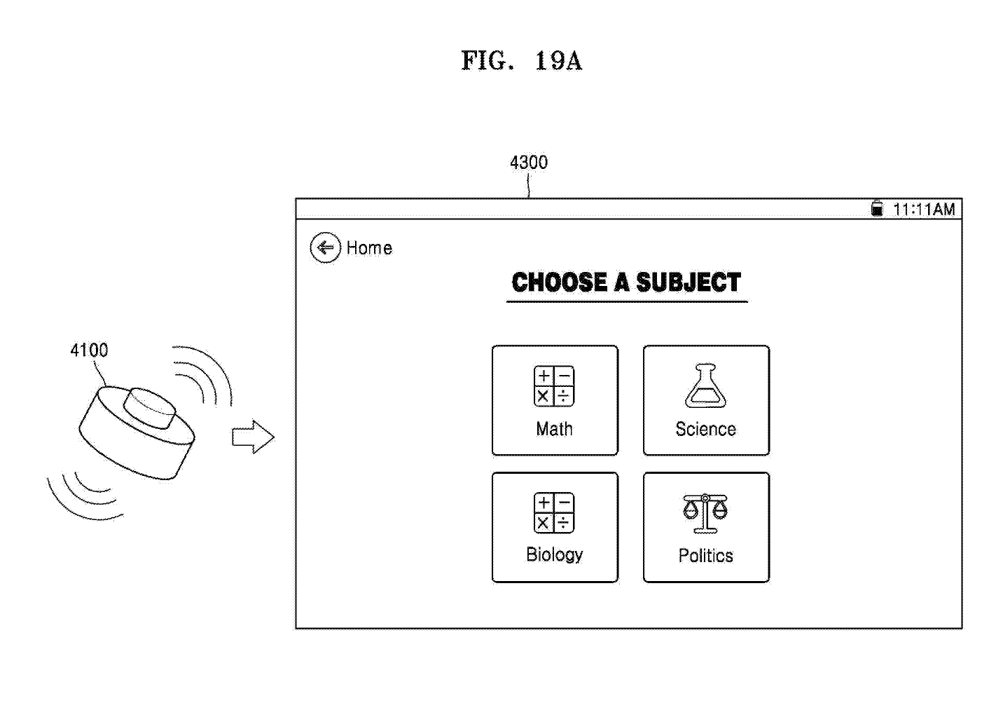

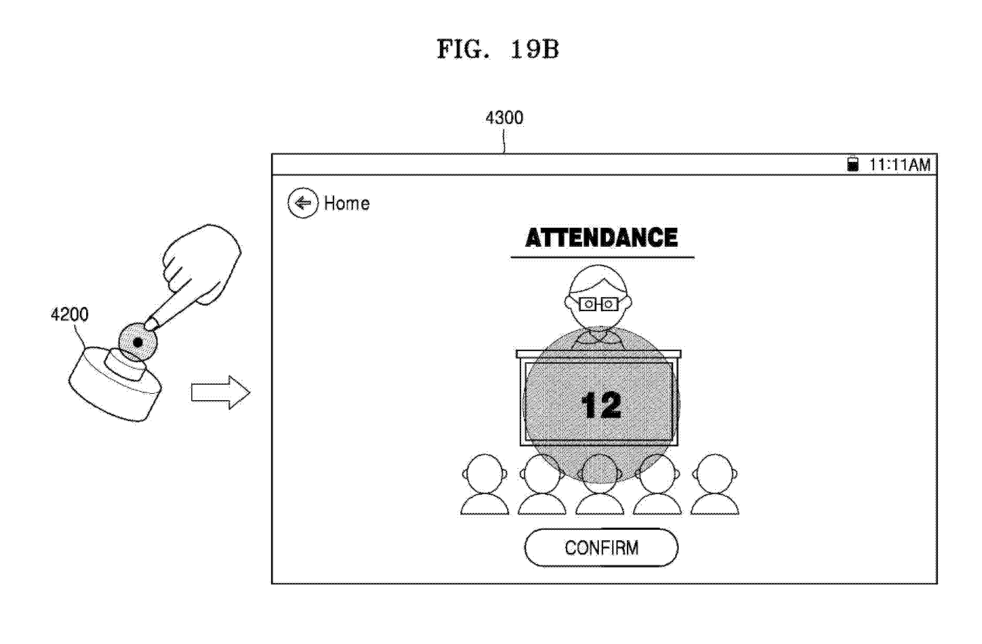

FIGS. 19A and 19B are diagrams of examples of providing class-related content by the hub device 4300 based on an identifier regarding a user input from the third external device 4100, according to some embodiments.

Referring to FIGS. 19A and 19B, an identifier regarding an input of shaking an external device is defined as a third identifier, and an identifier regarding an input of pressing a certain button on the external device short is defined as a first identifier. Also, FIG. 19A shows an example of matching the third identifier and an identifier regarding the third external device 4100 with a displayed subject list and matching the first identifier and an identifier regarding the fourth external device 4200 with the total number of students who attend the class.

Referring to FIG. 19A, when the input of shaking the third external device 4100 is identified, the third external device 4100 may transmit, to the hub device 4300, the third identifier as well as the third external device 4100 as the identifiers regarding the user inputs. In this case, the hub device 4300 may activate an application regarding the class and display the subject list on the screen, based on the third identifier and the identifier regarding the third external device 4100. In this case, the hub device 4300 may automatically select a subject that the teacher starts to teach, from the displayed subject list. For example, the hub device 4300 may automatically select a subject that the teacher starts to teach, in consideration of current time information and a class schedule of the teacher. Also, the hub device 4300 may select a subject that is about to start from the displayed subject list, based on a teacher's input.

Referring to FIG. 19B, when an input of pressing a button on the fourth external device 4200 short is identified after one subject is selected, the fourth external device 4200 may transmit, to the hub device 4300, the first identifier and the identifier regarding the fourth external device 4200 as the identifiers regarding the user inputs. In this case, the hub device 4300 may display, on the screen, the number of fourth external devices 4200 transmitting the first identifiers regarding the user inputs. For example, when 12 students, who attend the class, respectively press certain buttons on their fourth external devices 4200 short, ‘12’ that corresponds to the total number of students who attend the class may be displayed on the hub device 4300.

Although not shown in FIGS. 19A and 19B, when the first identifier and the identifier regarding the fourth external device 4200 match with the total number of students who finish assignments, if the students press buttons on their fourth external devices 4200 short, the hub device 4300 may display the total number of students who finishes the assignments.

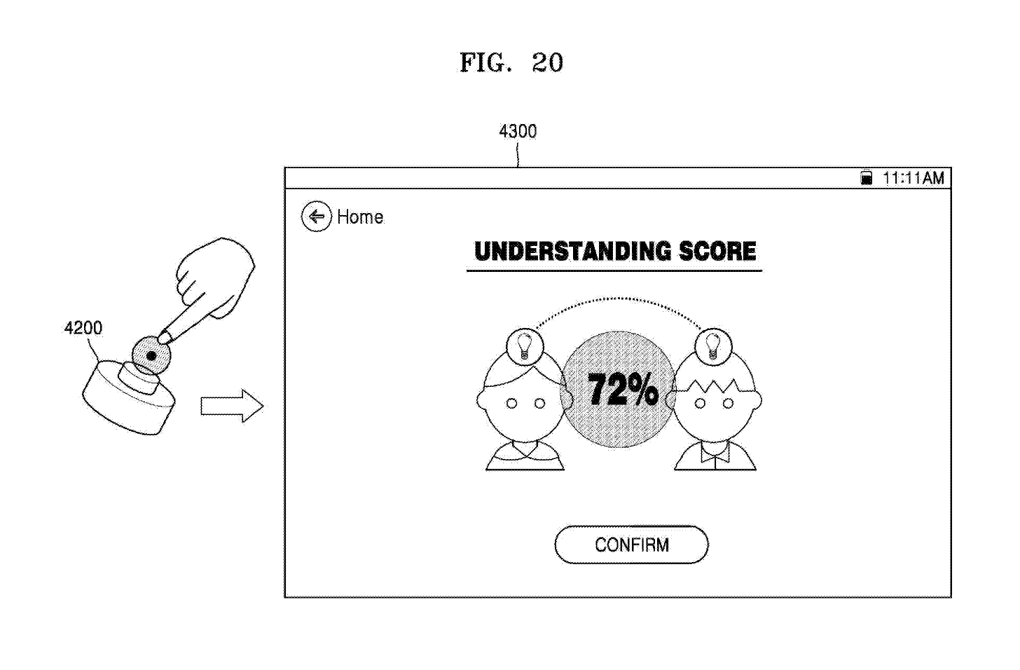

FIG. 20 is a diagram of an example of providing class-related content by the hub device 4300 when the identifier regarding the user input from the third external device 4100 is a first identifier, according to some embodiments.

FIG. 20 shows an example in which the first identifier and the identifier regarding the third external device 4100 match with a GUI for inducing a user input regarding the fourth external device 4200 and the first identifier and the identifier regarding the fourth external device 4200 match with a GUI for displaying how much the students understand the class.

When the input of pressing the button on the third external device 4100 short is identified, the third external device 4100 may transmit, to the hub device 4300, the first identifier and the identifier regarding the third external device 4100 as the identifiers regarding the user inputs. In this case, the hub device 4300 may display, on the screen, the GUI for inducing the user input regarding the fourth external device 4200, base on the first identifier and the identifier regarding the third external device 4100. Then, when the input of pressing the button on the fourth external device 4200 short is identified, the fourth external device 4200 may transmit, to the hub device 4300, the first identifier and the identifier regarding the fourth external device 4200 as the identifiers regarding the user inputs. In this case, the hub device 4200 may display, on the screen, the number or a ratio of fourth external devices 4200 that transmit the first identifiers regarding the user inputs.

For example, when students understand the class and then press buttons on their fourth external devices 4200 short, the hub device 4300 may display the number of students who understand the class or a ratio (e.g., 72%) of the students who understand the class to the whole students.

According to an embodiment, when different types of identifiers are received, the hub device 4300 may provide information based on a ratio of different types of identifiers. For example, the students who understand the class may press the buttons on their fourth external devices 4200 short, but students who do not understand the class may shake their fourth external devices 4200. In this case, the fourth external devices 4200 that the students who understand the class have may transmit the first identifiers to the hub device 4300, and the fourth external devices 4200 that the students who do not understand the class have may transmit the third identifiers to the hub device 4300. The hub device 4300 may determine the number of first identifiers and the number of third identifiers and may express a degree of understanding the class in figures or a graph based on the number of first identifiers and the number of third identifiers.

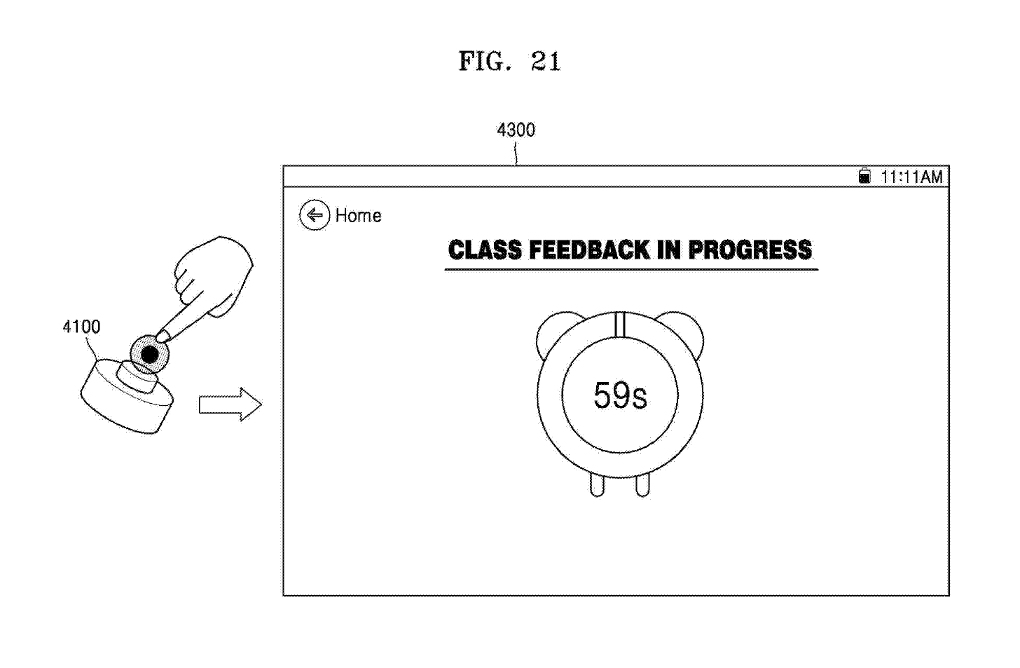

FIG. 21 is a diagram of an example of providing the class-related content by the hub device 4300 when an identifier regarding a user input from the third external device 4100 is a second identifier, according to some embodiments.

FIG. 21 shows an example in which the second identifier and the identifier regarding the third external device 4100 match with a GUI for inducing feedbacks from students on the class and the first identifier and the identifier regarding the fourth external device 4200 match with evaluation results of the students.

When an input of pressing the button on the third external device 4100 long is identified, the third external device 4100 may transmit, to the hub device 4300, the identifier regarding the third external device 4100 and the second identifier as the identifiers regarding the user inputs. In this case, the hub device 4300 may display, on the screen, the GUI for inducing the feedbacks from the students on the class. Then, when an input of pressing the button on the fourth external device 4200 short is identified, the fourth external device 4200 may transmit, to the hub device 4300, the first identifier and the identifier regarding the fourth external device 4200 as the identifiers regarding the user inputs. Also, when the input of pressing the button on the fourth external device 4200 long is identified, the fourth external device 4200 may transmit, to the hub device 4300, the second identifier and the identifier regarding the fourth external device 4200 as the identifiers regarding the user inputs. In this case, the hub device 4300 may display, on the screen, a remaining time (e.g., 59 seconds) during which the feedbacks on the class may be obtained. Also, the hub device 4300 may check the number of fourth external devices 4200 that transmit the same identifier regarding the user input and may store results of evaluating the class by the students.

For example, when the remaining time, during which the feedbacks on the class may be obtained, is being displayed on the hub device 4300, students who satisfy the class may press the buttons on their fourth external devices 4200 short, and students who do not satisfy the class may press the buttons on their fourth external devices 4200 long. In this case, the fourth external devices 4200 of the students who satisfy the class may transmit the first identifiers to the hub device 4300, and the fourth external devices 4200 of the students who do not satisfy the class may transmit the second identifiers to the hub device 4300. The hub device 4300 may determine the number of first identifiers and the number of second identifiers, may store the results of evaluating the class based on the number of first identifiers and the number of second identifiers, and may transmit the stored results to the server 3000.

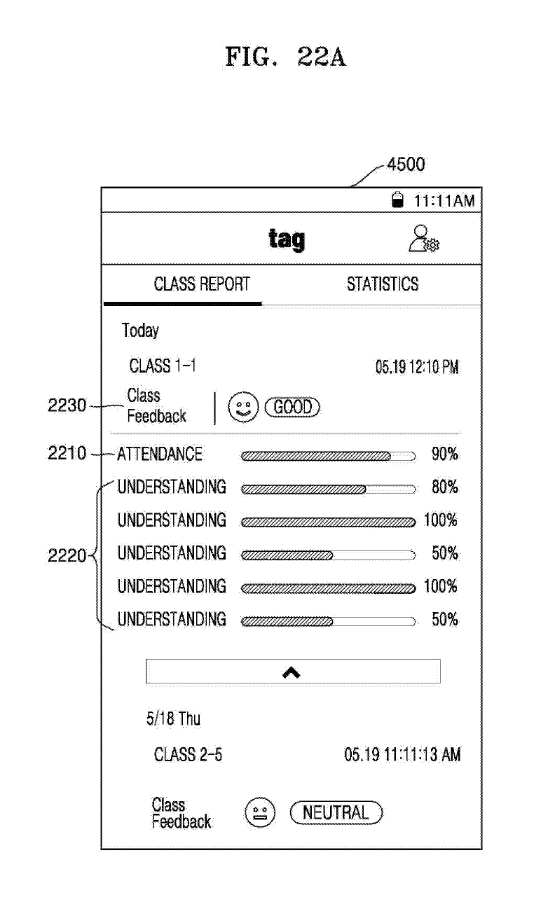

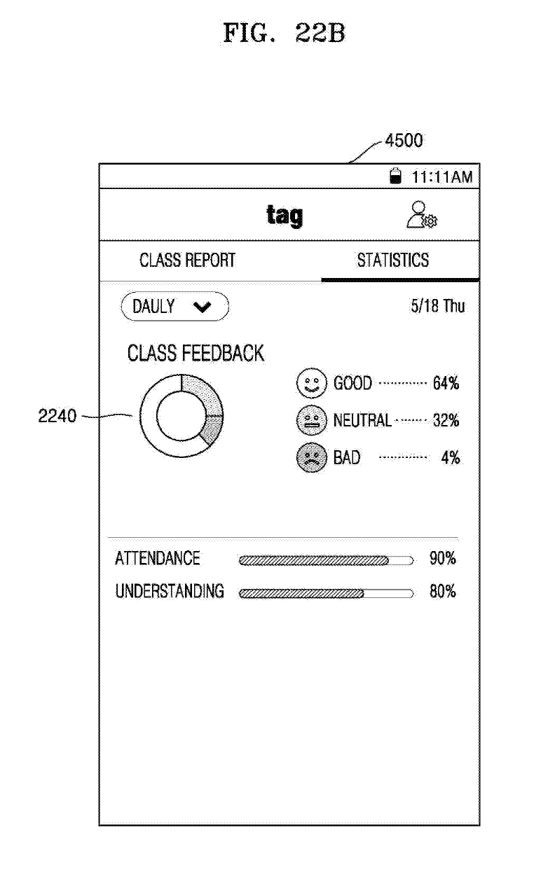

FIGS. 22A and 22B are diagrams of examples of providing class-related content by the mobile device 4500 of the teacher, according to some embodiments.

The mobile device 4500 of the teacher may receive the class-related content from the server 3000 and may provide the teacher with the received class-related content. In this case, the mobile device 4500 of the teacher may receive the class-related content from the server 3000 in real time. Also, the mobile device 4500 of the teacher may send a request for the class-related content to the server 3000 based on a user input, and the server 3000 may transmit the class-related content to the mobile device 4500 of the teacher in response to the request.

Referring to FIG. 22A, the mobile device 4500 of the teacher may display a student attendance rate 2210, a rate 2220 of students who understand the class, feedbacks 2230 from the students on the class, and the like. Here, the rate 2220 of students who understand the class may be measured several times according to content provided during classes. Thus, when a degree of understanding the class is measured several times, multiple rates 2210 may be displayed. Also, referring to FIG. 22B, the mobile device 4500 of the teacher may display the feedbacks from the students on the class (e.g., Good:Neutral:Bad=64%:32%:4%) in detail. Also, the mobile device 4500 of the teacher may display the feedbacks on the class in a donut chart 2240, but types of graphs are not limited thereto.

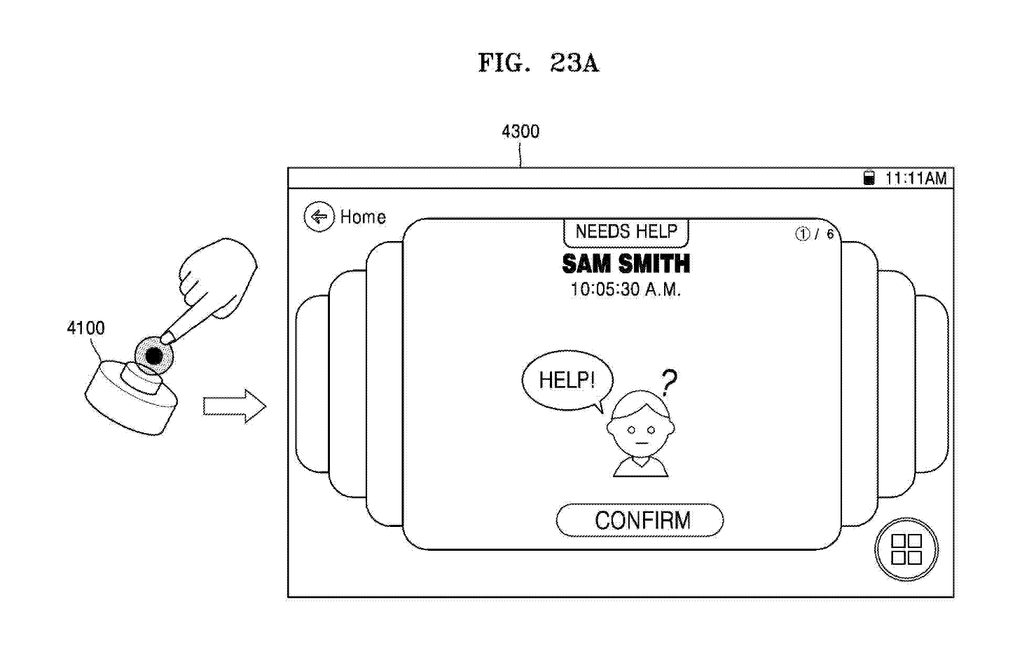

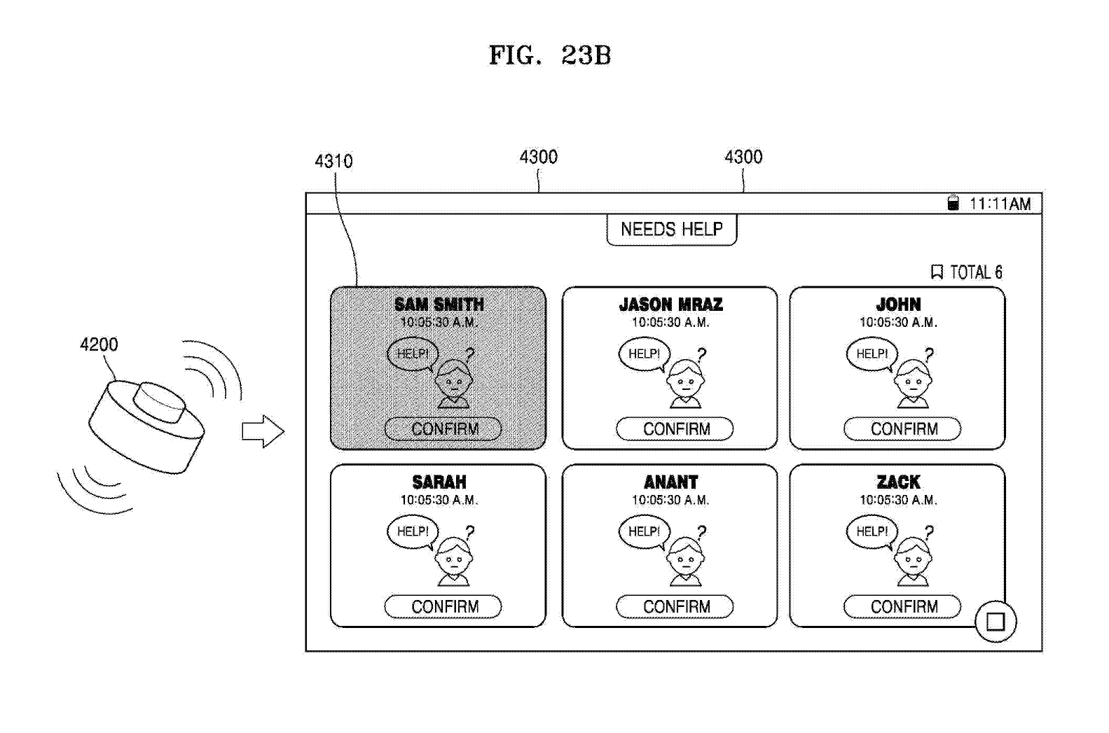

FIGS. 23A and 23B are diagrams of examples of providing class-related content by the hub device 4300 based on an identifier regarding a user input from the fourth external device 4200, according to some embodiments.

FIGS. 23A and 23B show examples in which the second identifier and the identifier regarding the fourth external device 4200 match with content regarding students who need help during the class and the third identifier and the identifier regarding the fourth external device 4200 match with content regarding students who no longer need help during the class.

Referring to FIG. 23A, during the class, when an input of pressing the button on the fourth external device 4200 long is identified, the fourth external device 4200 may transmit, to the hub device 4300, the second identifier and the identifier regarding the fourth external device 4200 as the identifiers regarding the user inputs. In this case, the hub device 4300 may display, on the screen, the content regarding the students who need help during the class. The hub device 4300 may display content regarding a student corresponding to the fourth external device 4200 that transmits most recently the second identifier or may display at one time content regarding students corresponding to the fourth external devices 4200 that transmit the second identifiers.

For example, when a student who needs help during the class presses a button on the fourth external device 4200 long, the hub device 4300 may display, on the screen, content (e.g., NEEDS HELP—SAM SMITH) regarding the student who pressed the button long.

Referring to FIG. 23B, when an input of shaking the fourth external device 4200 is identified after the content regarding the student who needs help during the class is displayed on the hub device 4300, the fourth external device 4200 may transmit, to the hub device 4300, the third identifier and the identifier regarding the fourth external device 4200 as the identifiers regarding the user inputs. In this case, the hub device 4300 may determine that the student corresponding to the fourth external device 4200 no longer needs help and may display a determination result, the fourth external device 4200 transmitting the third identifier.

For example, the hub device 4300 may display content regarding students, including Sam Smith, who need help. Then, when Sam Smith shakes his fourth external device 4200, the hub device 4300 may determine that Sam Smith no longer needs help and thus may shade and display information 4310 regarding Sam Smith.

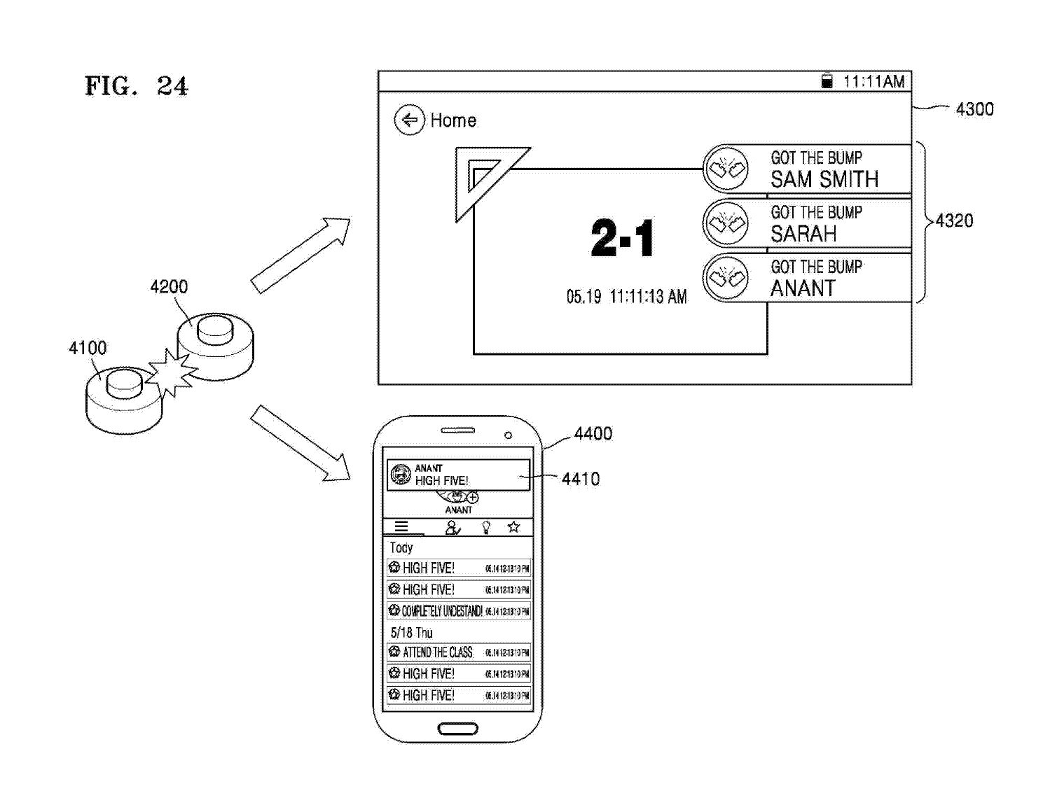

FIG. 24 is a diagram of an example of providing class-related content by the hub device 4300 when an identifier regarding a user input is an identifier indicating a collision between the third external device 4100 and the fourth external device 4200, according to some embodiments.

FIG. 24 shows an example in which the identifier indicating the collision between the third external device 4100 and the fourth external device 4200 and the identifier regarding the fourth external device 4200 match with content regarding students who get praised by the teacher during the class.

Referring to FIG. 24, the hub device 4300 may determine that the third external device 4100 collides with the fourth external device 4200. In particular, for a certain time period (e.g., 2 seconds), when identifiers regarding an input of shaking the third external device 4100 and an input of shaking the fourth external device 4200 are respectively received from the third external device 4100 and the fourth external device 4200, the hub device 4300 may determine that the third external device 4100 collides with the fourth external device 4200. However, a method of determining, by the hub device 4300, the collision between the third external device 4100 and the fourth external device 4200 is not limited thereto.

If it is determined that the third external device 4100 collides with the fourth external device 4200, the hub device 4300 may display the content regarding the students who get praised by the teacher during the class. In addition, the hub device 4300 may transmit, to the server 3000, the identifier regarding the fourth external device 4200 and the content regarding the students who get praised during the class.

For example, the teacher may have his/her external device colliding with an external device of a student that the teacher plans to praise during the class. In this case, the hub device 4300 may determine that the teacher's external device collides with the external device of the student and may display content (e.g., GOT THE BUM—SAM SMITH) regarding the student who gets praised during the class. If the teacher has his/her external device colliding with external devices of students (e.g., Sam Smith, Sarah, and Anant) several times, the hub device 4300 may display at one time content 4320 regarding the students who get praised during the class. Also, the hub device 4300 may transmit, to the server 3000, the identifier regarding the fourth external device 4200 and the content 4320 regarding the students who get praised.

Although not shown in FIG. 24, the server 3000 may use the identifier regarding the fourth external device 4200 which is received from the hub device 4300 so as to search for information regarding parents of student corresponding to the fourth external device 4200. For example, the server 3000 may store information regarding students who attend the class and parents of the students. In this case, when the server 3000 receives the identifier regarding the fourth external device 4200 and the content regarding the student who gets praised, the server 3000 may match the fourth external device 4200 with the student and then may search for information regarding the parents of the student. Also, the server 3000 may provide the content regarding the student, who gets praised, to a mobile device 4400 of a parent in real time, based on a search result. In addition, the mobile device 4400 of the parent may send a request for the content regarding the student who gets praised to the server 3000 according to a user input, and the server 3000 may transmit the content regarding the student, who gets praised, to the mobile device 4400 in response to the request.

For example, when a collision between an external device of a student (e.g., Anant) and the external device of the teacher occurs during the class, the hub device 4300 may transmit an identifier regarding the external device of the student to the server 3000. The server 3000 may search for information regarding parents of the student (e.g., Anant's parents) based on the identifier regarding the external device of the student. Also, the server 3000 may send, to the mobile device 4400, a notification that the student got praised during the class. In this case, the mobile device 4400 may display a message 4410 (e.g., ANANT—HIGH FIVE) saying that the student got praised by the teacher.

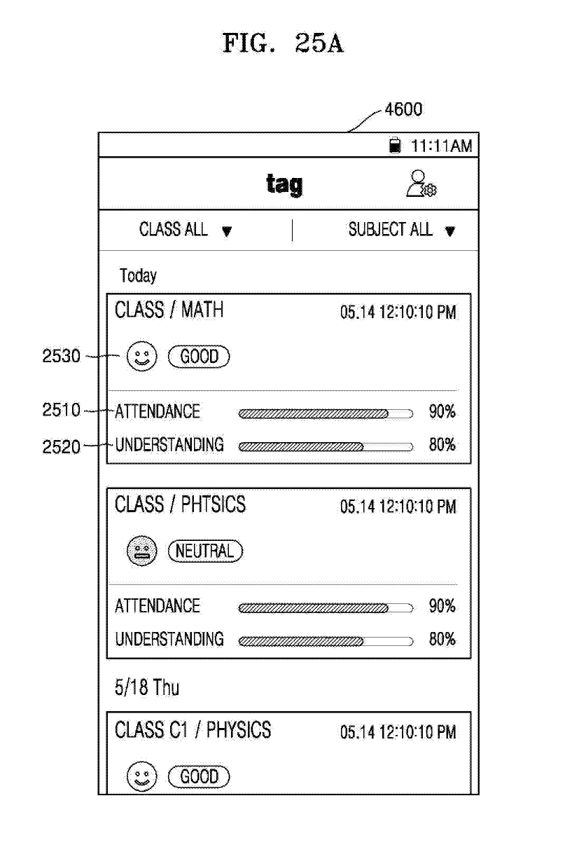

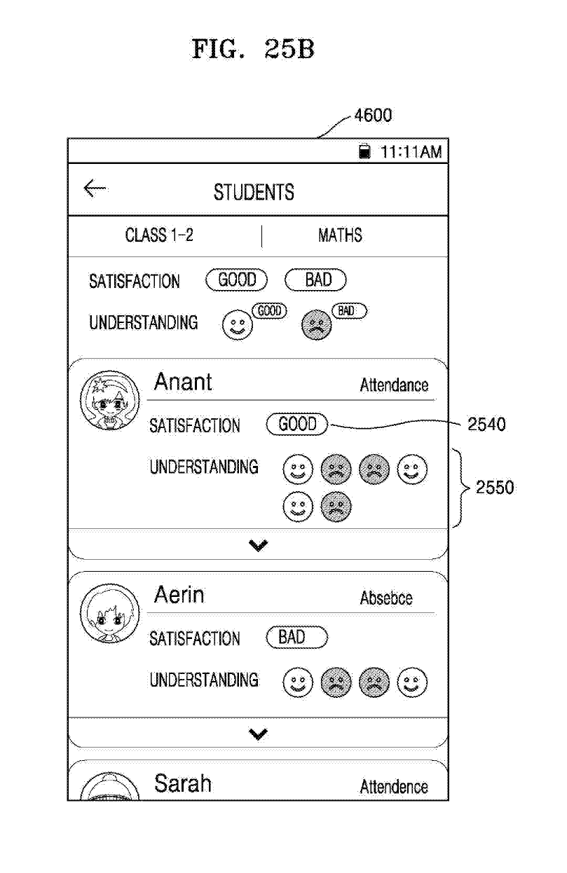

FIGS. 25A and 25B are diagrams of examples of providing class-related content by a mobile device 4600 of a head teacher, according to some embodiments.

The mobile device 4600 of the head teacher may receive the class-related content from the server 3000 and may provide the head teacher with the received class-related content. In this case, the mobile device 4600 may receive the class-related content from the server 3000 in real time. In addition, the mobile device 4600 may send a request for the class-related content to the server 3000 based on a user input, and the server 3000 may transmit, to the mobile device 4600, the class-related content in response to the received request.

Referring to FIG. 25A, the mobile device 4600 may display an attendance rate 2510 of whole classes, a rate 2520 of students who understand classes, feedbacks 2530 from students on the classes, and the like. Moreover, referring to FIG. 25B, the mobile device 4600 may display detailed information regarding students who attend a certain class. For example, the mobile device 4600 may display in detail a feedback 2540 from a student (e.g., Anant) who attends Math class in class 1-2, and a degree 2550 of understanding the class.

Some embodiments can be embodied as a non-transitory computer-readable recording medium, for example, a program module, which includes instructions executable by a computer. The non-transitory computer-readable recording medium may be an arbitrarily available medium that may be accessed by a computer and may include a volatile medium, a non-volatile medium, a removable medium, and a non-removable medium. Also, the non-transitory computer-readable recording medium may include a computer storage medium and a communication medium. The computer storage medium includes a volatile medium, a non-volatile medium, a removable medium, and a non-removable medium that is embodied by an arbitrary method or technology in order to store information such as computer-readable instructions, data structures, program modules, or other types of data. The communication medium may generally include computer-readable instructions, data structures, program modules, data having modulated data signals, or other transmission mechanisms and may also include an arbitrary information transmission medium.

Also, the “unit” may be implemented as a hardware component such as a processor or a circuit, and/or a software component executed by a hardware component such as a processor.

It should be understood that embodiments described herein should be considered in a descriptive sense only and not for purposes of limitation. Descriptions of features or aspects within each embodiment should typically be considered as available for other similar features or aspects in other embodiments. For example, components of a single type may be executed in a distributed manner, and components of a distributed type may be integrated.

While one or more embodiments have been described with reference to the figures, it will be understood by one of ordinary skill in the art that various changes in form and details may be made therein without departing from the spirit and scope as defined by the following claims.

What is claimed is:

1. A mobile device comprising:
a memory in which at least one program is stored;
at least one communicator configured to exchange data with an external device and a server; and
a processor configured to provide content about the external device by executing the at least one program,
wherein the at least one program comprises instructions to perform:
receiving an identifier regarding the external device and an identifier regarding a user input that is input to the external device from the external device;
transmitting the identifier regarding the external device and the identifier regarding the user input to the server;
receiving content about the external device and the user input from the server, based on the identifier regarding the external device and the identifier regarding the user input; and
displaying the received content on a screen.

2. The mobile device of claim 1, wherein the received content comprises content received from the server to provide a social networking service (SNS).

3. The mobile device of claim 1, wherein the received content comprises content determined by the server based on information about a product regarding the external device.

4. The mobile device of claim 3, wherein the information about the product comprises at least one of a model name, a serial number, a manufacture number, and a product number of the product.

5. The mobile device of claim 1, wherein, in the receiving of the content, detailed information for using a product regarding the external device is received from the server when the identifier regarding the user input is a first identifier.

6. The mobile device of claim 1, wherein, in the receiving of the content, a graphical user interface (GUI) for uploading data about a product regarding the external device is received from the server when the identifier regarding the user input is a second identifier.

7. The mobile device of claim 1, wherein, in the receiving of the content, a GUI for communicating with another user who uses a product that is identical to a product regarding the external device is received from the server when the identifier regarding the user input is a third identifier.

8. The mobile device of claim 7, wherein the at least one program further comprises instructions to perform making a video call to the another user by using the GUI for communicating with the another user.

9. The mobile device of claim 1, wherein, when the identifier regarding the user input indicates a user input of colliding the external device with another external device, the receiving of the content comprises receiving, from the server, a video comprising a scene in which a product regarding the external device and a product regarding the another external device are used together.

10. The mobile device of claim 1, wherein the at least one program further comprises instructions to perform:
displaying a GUI for determining whether to display the content about the external device when the identifier regarding the external device and the identifier regarding the user input are received; and
determining whether to display the content about the external device, based on a user input through the displayed GUI.

11. A method of providing, by a mobile device, content about an external device, the method comprising:
receiving an identifier regarding the external device and an identifier regarding a user input that is input to the external device, from the external device;
transmitting the identifier regarding the external device and the identifier regarding the user input to a server;
receiving content about the external device and the user input from the server, based on the identifier regarding the external device and the identifier regarding the user input; and
displaying the received content on a screen.

12. The method of claim 11, wherein the received content comprises content received from the server to provide a social networking service (SNS).

13. The method of claim 11, wherein the received content comprises content determined by the server based on information about a product regarding the external device.

14. The method of claim 13, wherein the information about the product comprises at least one of a model name, a serial number, a manufacture number, and a product number of the product.

15. The method of claim 11, wherein, in the receiving of the content, detailed information for using a product regarding the external device is received from the server when the identifier regarding the user input is a first identifier.

16. The method of claim 11, wherein, in the receiving of the content, a graphical user interface (GUI) for uploading data about a product regarding the external device is received from the server when the identifier regarding the user input is a second identifier.

17. The method of claim 11, wherein, in the receiving of the content, a GUI for communicating with another user who uses a product that is identical to a product regarding the external device is received from the server when the identifier regarding the user input is a third identifier.

18. The method of claim 17, further comprising making a video call to the another user by using the GUI for communicating with the another user.

19. The method of claim 11, wherein, when the identifier regarding the user input indicates a user input of colliding the external device with another external device, the receiving of the content comprises receiving, from the server, a video comprising a scene in which a product regarding the external device and a product regarding the another external device are used together.

20. A non-transitory computer-readable recording medium having recorded thereon a program which, when executed by a computer, performs the method of claim 11.
